(19) United States
(12) Patent Application Publication
(10) Pub. No.: US 2026/0338716 A1
(43) Pub. Date: Oct. 29, 2026

(54) METHODS FOR ELECTRON DIFFRACTION IMAGING

(71) Applicants: California Institute of Technology, Pasadena, CA (US); The Regents of the University of California, Okland, CA (US)

(72) Inventors: Dmitry Eremin, Pasadena, CA (US); Jose A. Rodriguez, Los Angeles, CA (US); Hosea M. Nelson, Pasadena, CA (US); Hongyu Zhang, Pasadena, CA (US)

(21) Appl. No.: 19/631,342

(22) Filed: Mar. 27, 2026

Related U.S. Application Data
(60) Provisional application No. 63/778,712, filed on Mar. 27, 2025.
(60) Provisional application No. 63/802,450, filed on May 8, 2025.

(51) Int. Cl. G01N 23/20058; G01N 23/2055

(52) U.S. Cl. CPC G01N 23/20058; G01N 23/2055; G01N 2223/304

(57) ABSTRACT

The present disclosure relates to methods for electron diffraction data acquisition and real-time processing of electron diffraction imaging data.

### RELATED APPLICATIONS

This application claims the benefit of priority to U.S. Provisional Application No. 63/778,712, filed Mar. 27, 2025, and U.S. Provisional Application No. 63/802,450, filed May 8, 2025, the contents of each of which are incorporated herein by reference in their entirety.

### BACKGROUND

Electron diffraction, including microcrystal electron diffraction (microED) and three-dimensional electron diffraction (3DED), has emerged as a technique for determining molecular structures of inorganic, organic, and biological molecules, macromolecules, and materials. Current approaches to electron diffraction data collection often rely on semi-automated workflows that require human intervention for tasks such as crystal selection, data verification, and execution of intermediate steps. Alternative approaches that employ computer vision-based particle recognition for crystal selection can result in collection of substantial amounts of low-quality data, consuming instrument time and storage resources. Additionally, data quality can vary due to factors including poorly diffracting particles, crystal drift, and sample movement. In view of the foregoing, there is an unmet need to develop new methods for electron diffraction imaging.

### SUMMARY

In some aspects, the present disclosure provides methods of determining the crystal structure of a molecule, comprising:
providing a sample grid comprising a plurality of crystals of the molecule;
contacting the plurality of crystals with an incident beam of electrons; thereby generating a plurality of diffraction snapshots from each of a plurality of discrete locations within an area of the sample grid;
assessing, using a classification algorithm, a quality of the plurality of diffraction snapshots based on a total diffraction intensity, a number of diffraction peaks, and a crystallite lattice quality; thereby generating a diffraction quality classification;
generating a ranked list of crystal targets based on the diffraction quality classification;
selecting a subset of crystal targets based on their ranking in the ranked list of crystal targets;
obtaining one or more redundant diffraction data sets from the subset of crystal targets; and
applying direct methods to the one or more redundant diffraction data sets; thereby determining the crystal structure of the molecule;
wherein the one or more redundant diffraction data sets comprise an improved parameter selected from completeness, Rᵢₙₜ, I/σ, and R_{merge}, as compared to one or more redundant diffraction data sets generated without the classification algorithm.

In some aspects, the present disclosure provides methods of determining the crystal structure of a molecule, comprising:
providing a sample grid comprising a plurality of crystals of the molecule;
contacting the plurality of crystals with an incident beam of electrons; thereby generating a plurality of diffraction snapshots from each of a plurality of discrete locations within an area of the sample grid;
generating a diffraction quality classification using a means for assessing a quality of the plurality of diffraction snapshots;
generating a ranked list of crystal targets using a means for correlating the ranked list of crystal target with the diffraction quality classification;
selecting a subset of crystal targets based on their ranking in the ranked list of crystal targets;
obtaining one or more redundant diffraction data sets from the subset of crystal targets using a means for obtaining one or more redundant diffraction data sets; and
applying direct methods to the one or more redundant diffraction data sets; thereby determining the crystal structure of the molecule.

### BRIEF DESCRIPTION OF THE DRAWINGS

FIGS. 1A-1G depict the steps of the REyes workflow. FIG. 1A depicts a sample grid square with selected targets. FIG. 1B depicts generation of a diffraction atlas for selected targets. FIG. 1C depicts the serialEM pixel space output and real space output. FIG. 1D depicts the reciprocal space map of the grid square. FIG. 1E depicts intensity, pattern, and quality analysis of the diffraction map. FIG. 1F depicts the diffraction quality classification. FIG. 1G depicts a structural determination with REyes workflow requiring <0.5 h data acquisition time.

FIGS. 2A-2D depict the REyes workflow. FIG. 2A depicts a grid montage (atlas) with identified grid squares. FIG. 2B depicts a eucentric height adjustment step based on eucentric plane regression. FIG. 2C depicts an overlay of low-magnification images of selected grid squares with several detected diffraction peaks map. FIG. 2D depicts an example of selected grid square low-magnification image with intensity, number of diffraction peaks, number of Fourier transformation peaks, and diffraction quality maps obtained with on-the-fly data processing and possible acquisition locations. Note: All low magnification images are offset compared to diffraction space.

FIGS. 3A-3C depict REyes, AutoProcess, and AutoSolve outcomes for a sample. FIG. 3A depicts a diffraction quality map of the (S,S)-salen ligand 1 grid. FIG. 3B depicts diffraction snapshots of highest ranked targets by quality, peak number, and intensity. FIG. 3C depicts a Target 213 REyes ‘Quality’ diffraction map of a grid square resulting in a single-movie solution, a diffraction snapshot at 0.8 Å max resolution of the target selected by REyes, Fobs map for ab initio preliminary solution 0.8 Å and refined structure of. Priority targets included items 101, 205, and 307 (see also Table 1).

FIGS. 4A-4D depict REyes, AutoProcess, AutoSolve and refinement results of an autonomous microED acquisition. REyes ‘Quality’ diffraction map of a grid square led to a single-movie solution, diffraction snapshot at 0.8 Å max resolution of the target selected by REyes, Fobs map for ab initio preliminary solution 0.8 Å and refined structure of grossular (2) (FIG. 4A), biotin (3) (FIG. 4B) AVAAGA peptide (4) (FIG. 4C) and Cu(D-Ser)₂ (5) (FIG. 4D) samples.

FIGS. 5A-5C depict an autonomous microED workflow for cactus extract using REyes. FIG. 5A depicts violin plots of I/σ completeness, Rmeas, and CC½ across 54 successfully processed movies. Circles represent individual dataset results, where circles resulted in successful ab initio phasing of an unknown compound from a cactus crude extract; box plots within the violins indicate median and interquartile ranges. FIG. 5B depicts a diffraction pattern for target 101 resulting in the best preliminary phasing. FIG. 5C depicts merged REyes targets used for the final ab initio phasing and refinement of mescaline hydrochloride.

FIGS. 6A-6F depict a comparison of diffraction data quality metrics obtained by REyes. FIG. 6A depicts a row-normalized (recall) confusion matrix showing how each manually assigned category (rows) maps onto REyes classifications (columns). FIG. 6B depicts bar plots comparing completeness of solutions from single microED movies obtained by REyes and acquired manually. FIG. 6C depicts bar plots comparing Rint of solutions from single microED movies obtained by REyes and acquired manually. FIG. 6D depicts bar plots comparing I/σ of solutions from single microED movies obtained by REyes and acquired manually. Pentagon point represents (S,S)-salen ligand 1. FIG. 6E depicts Rmerge values plotted against 20 resolution. FIG. 6F depicts Fractal dimension measurements for REyes versus manual data collection.

FIGS. 7A & 7B depict a flowchart illustrating the REyes autonomous workflow logic, from initial grid imaging at low magnification to the preliminary ab initio phasing solution. FIG. 7A depicts workflow steps 1-6b. FIG. 7B depicts workflow steps 7-9 and the end of the workflow.

FIG. 8 depicts REyes diffraction quality classification examples. Top to bottom ‘Grid’, ‘No Diffraction’, ‘Poor Diffraction’, ‘Bad Diffraction’, and ‘Good Diffraction’ Patterns.

FIGS. 9A-9B depict normalized confusion matrices comparing manual and REyes diffraction quality labels. FIG. 9A depicts matrices for the REyes session of a (S,S)-salen ligand 1 sample, acquired using a Talos F200C microscope equipped with a DE Apollo camera. The x-axis represents the REyes-assigned labels, while the y-axis corresponds to the manually assigned labels. The color intensity indicates the proportion of predictions for each manual label, with values normalized across rows. FIG. 9B depicts for the REyes session of a biotin 3 sample, acquired using a Talos F200C microscope equipped with a DE Apollo camera. The x-axis represents the REyes-assigned labels, while the y-axis corresponds to the manually assigned labels. The intensity indicates the proportion of predictions for each manual label, with values normalized across rows.

FIGS. 10A-10B depict REyes diffraction quality parametric comparisons. FIG. 10A depicts lattice quality peaks (LQP) versus indexing success rates of all acquired microED data (214 movies) binned by the LQP number representing periodicity and quality of original diffraction snapshots of the selected crystalline targets. Data with LQP>10 are grouped into bins of 20. FIG. 10B depicts diffraction quality index (DQI) versus indexing success rates of all acquired microED data (214 movies) binned by the DQI representing periodicity and quality of original diffraction snapshots balanced by the number of the diffraction peaks of the selected crystalline targets. REyes classifies snapshots with DQI≤1 as ‘Bad diffraction class’. Data with DQI>1 are grouped into bins of 20.

FIGS. 11A-11C depict REyes diffraction quality parametric comparisons. FIG. 11A depicts a scatter plot for the LQP versus CC½ values (left) and DQI versus CC½ values (right) of successfully indexed microED datasets. Each point represents one crystalline target from the subset of 136 movies that achieved successful indexing. FIG. 11B depicts a scatter plot for the LQP versus Rmeas values (left) and DQI versus Rmeas values (right) of successfully indexed microED datasets. Each point represents one crystalline target from the subset of 136 movies that achieved successful indexing. FIG. 11C depicts a scatter plot for the LQP versus I/σ values (left) and DQI versus I/σ values (right) of successfully indexed microED datasets. Each point represents one crystalline target from the subset of 136 movies that achieved successful indexing.

FIGS. 12A-12B depict phasing success rates of indexed microED data. FIG. 12A depicts phasing success rates of all small molecule successfully indexed microED data (120 movies) binned by the LQP number representing periodicity and quality of original diffraction snapshots of the selected crystalline targets. Data with LQP>10 are grouped into bins of 20. FIG. 12B depicts phasing success rates of all small molecule successfully indexed microED data (120 movies) binned by the DQI representing periodicity and quality of original diffraction snapshots balanced by the number of the diffraction peaks of the selected crystalline targets. REyes classifies snapshots with DQI≤1 as ‘Bad diffraction class’. Data with DQI>1 are grouped into bins of 20.

FIGS. 13A-13D depict crystallographic data comparisons of REyes analysis versus human analysis. FIG. 13A depicts bar plots comparing completeness, I/σ, Rint, and Rmeas from all indexed microED movies collected by REyes and by the Expert from the same biotin grid. FIG. 13B depicts violin plots comparing completeness, I/σ, Rint, and Rmeas from all indexed microED movies collected by REyes and by the Expert from the same biotin grid. The pentagon symbol marks the best dataset. FIG. 13C depicts bar plots comparing completeness, I/σ, Rint, and Rmeas from top 5 microED movies collected by REyes and by the Expert from the same biotin grid. FIG. 13D depicts violin plots comparing completeness, I/σ, Rint, and Rmeas from top 5 microED movies collected by REyes and by the Expert from the same biotin grid. The pentagon symbol marks the best dataset.

FIGS. 14A-14C depict representative diffraction snapshots from the “bad diffraction” DQI category. FIG. 14A depicts representative bad diffraction snapshot 1. FIG. 14B depicts representative bad diffraction snapshot 2. FIG. 14C depicts representative bad diffraction snapshot 3.

FIGS. 15A-15C depict representative diffraction snapshots from the “good diffraction” DQI category. FIG. 15A depicts representative good diffraction snapshot 1. FIG. 15B depicts representative good diffraction snapshot 2. FIG. 15C depicts representative good diffraction snapshot 3. Notably, in comparison with FIGS. 14A-14C, all 6 representative diffraction snapshots comprise diffraction peaks close to the edge of the frame (high resolution reflections). Existing approaches of checking for the presence of ‘high resolution diffraction’ would include bad diffraction snapshots 1-3 in the “good diffraction” category, whereas the DQI of the present disclosure rejects these diffraction snapshots.

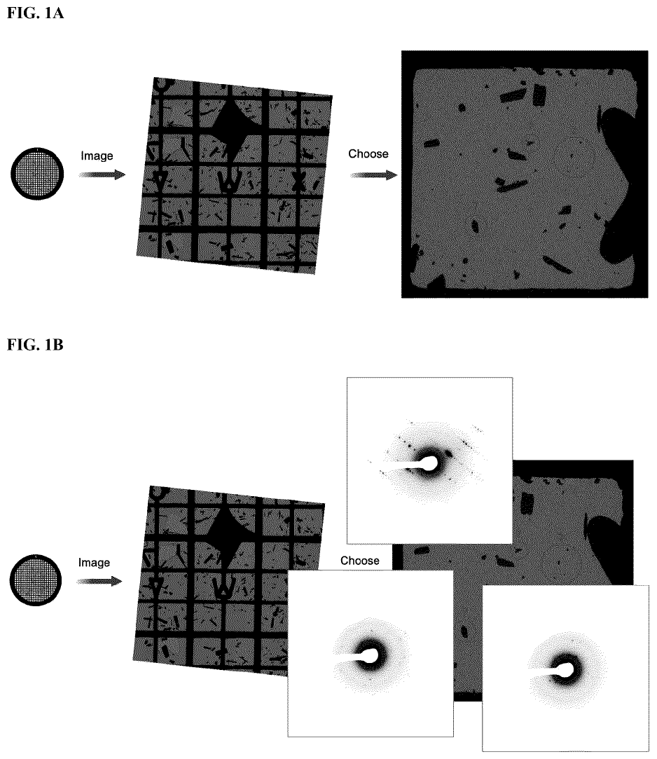

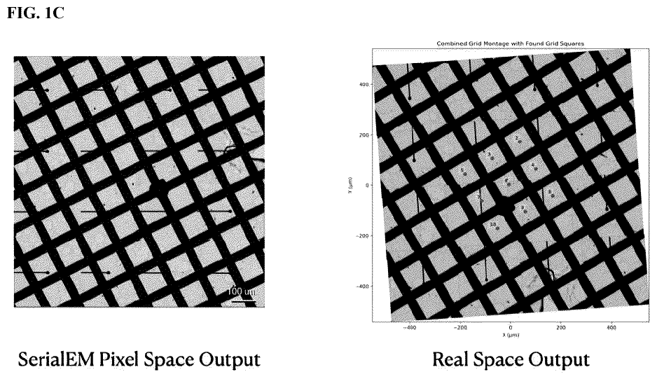

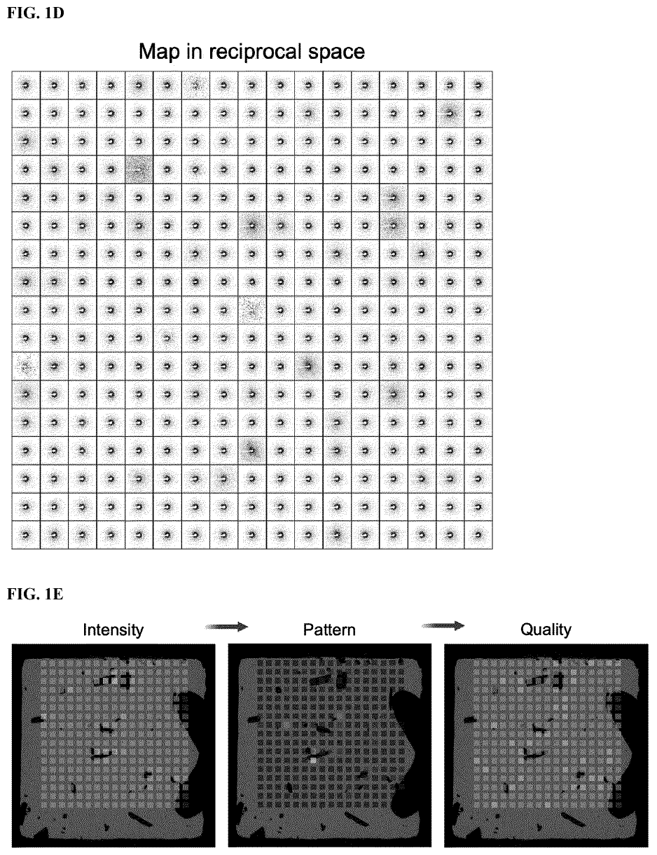

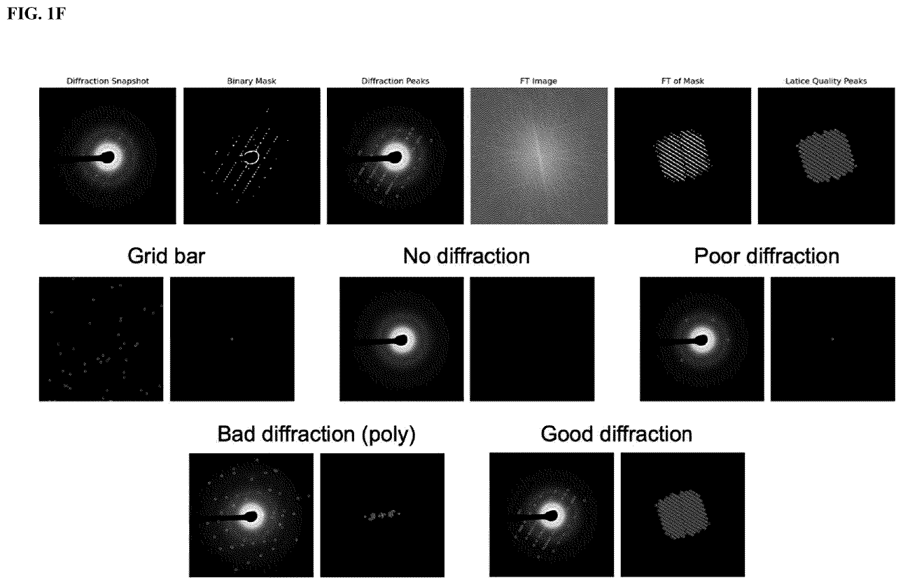

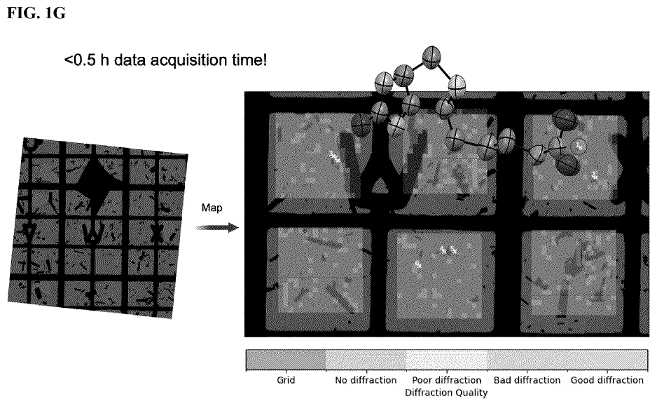

### DETAILED DESCRIPTION

In some aspects, the present disclosure provides methods of determining the crystal structure of a molecule, comprising:
providing a sample grid comprising a plurality of crystals of the molecule;
contacting the plurality of crystals with an incident beam of electrons; thereby generating a plurality of diffraction snapshots from each of a plurality of discrete locations within an area of the sample grid;
assessing, using a classification algorithm, a quality of the plurality of diffraction snapshots based on a total diffraction intensity, a number of diffraction peaks, and a crystallite lattice quality; thereby generating a diffraction quality classification;
generating a ranked list of crystal targets based on the diffraction quality classification; selecting a subset of crystal targets based on their ranking in the ranked list of crystal targets;
obtaining one or more redundant diffraction data sets from the subset of crystal targets; and applying direct methods to the one or more redundant diffraction data sets; thereby determining the crystal structure of the molecule;
wherein the one or more redundant diffraction data sets comprise an improved parameter selected from CC½, completeness, Rᵢₙₜ, I/σ, and R_{merge}, or combinations thereof, as compared to one or more redundant diffraction data sets generated without the classification algorithm.

In some aspects, the present disclosure provides methods of determining the crystal structure of a molecule, comprising:
providing a sample grid comprising a plurality of crystals of the molecule;
contacting the plurality of crystals with an incident beam of electrons; thereby generating a plurality of diffraction snapshots from each of a plurality of discrete locations within an area of the sample grid;
generating a diffraction quality classification using a means for assessing a quality of the plurality of diffraction snapshots;
generating a ranked list of crystal targets using a means for correlating the ranked list of crystal target with the diffraction quality classification;
selecting a subset of crystal targets based on their ranking in the ranked list of crystal targets;
obtaining one or more redundant diffraction data sets from the subset of crystal targets using a means for obtaining one or more redundant diffraction data sets; and
applying direct methods to the one or more redundant diffraction data sets; thereby determining the crystal structure of the molecule.

Electron diffraction (ED) has emerged as a practical tool for structural characterization of organic molecules, a rise fueled by technological breakthroughs in continuous rotation data collection (microcrystal electron diffraction—microED, 3D ED), advanced transmission electron microscope (TEM) instrumentation, and algorithmic innovations adapted from single-crystal X-ray diffraction (SCXRD). These developments, originating largely from progress in CryoEM and SCXRD, have enabled ED to transition from a niche technique to one with broad applications across natural products (NPs) discovery, polymer science, metal-organic frameworks (MOFs), and soft materials chemistry, amongst others.

However, the growing use of ED has underscored the need for tools tailored specifically to microED, rather than retrofits of cryoEM or SCXRD workflows, which are time-consuming and heavily reliant on human intervention. Although semi-automated tools such as Instamatic, RED, SerialED, and other “in-house” scripts and programs have emerged from academic labs, their adoption is limited by compatibility issues across diverse TEM platforms, or a requirement for highly specialized knowledge. Meanwhile, commercial solutions offer partially automated subroutines, but are only available with proprietary hardware. Moreover, none of the aforementioned solutions provide a truly autonomous, end-to-end workflow from sample entry to a crystal structure.

The present disclosure provides a fully autonomous microED software suite—Reciprocal Eyes (REyes). It combines SerialEM-based ED acquisition and a Python package for intelligent real-time acquisition and analysis. REyes replaces human-driven, time-consuming microED procedures, such as particle selection, with automated machine-driven whole-grid diffraction mapping and particle selection based on diffraction quality, rather than real-space visualization.

A selection algorithm leveraging Patterson space criteria enables REyes to autonomously identify well-diffracting regions most likely to yield structural solutions from a single dataset. When paired with automated data reduction (AutoProcess) and phasing (AutoSolve) modules, REyes forms an end-to-end microED pipeline that outperforms manual workflows completed in this study by experts. Its robustness is demonstrated across four uniquely configured TEMs at two universities and the platform is validated by solving structures of (S,S)-salen ligand (1), grossular (2), biotin (3), hexapeptide AVAAGA (4), transition metal complex Cu(D-Ser)₂ (5), citrinovirin (6), N-methyl mescaline (7), and carbamazepine (8).

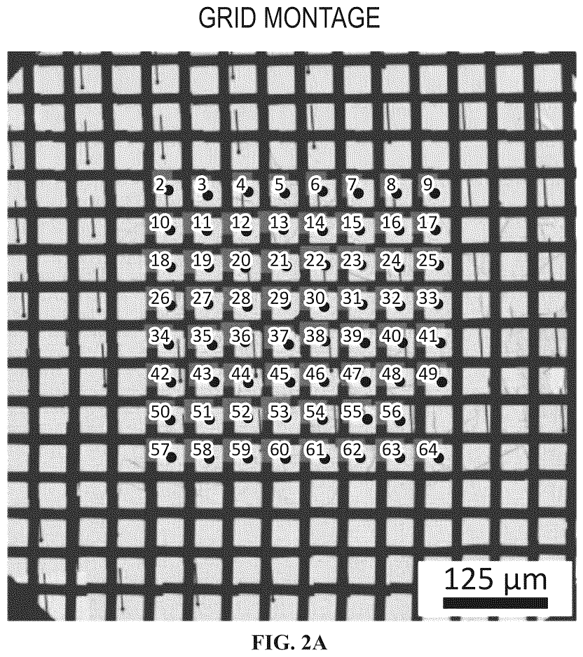

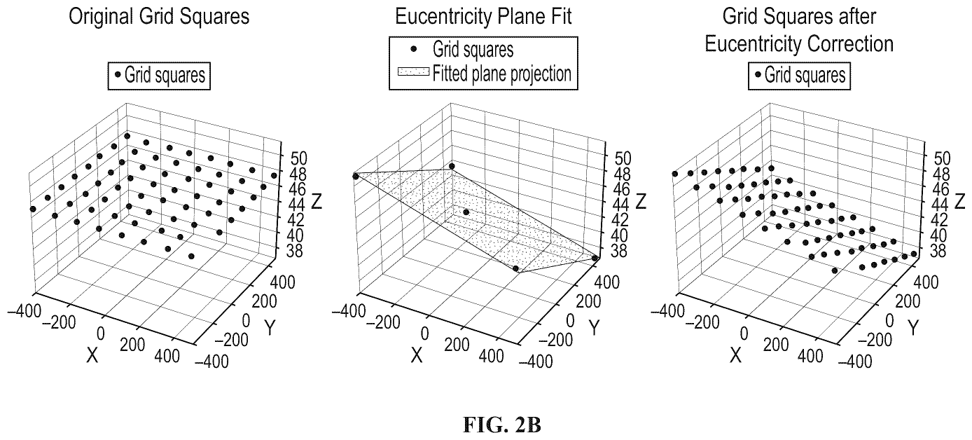

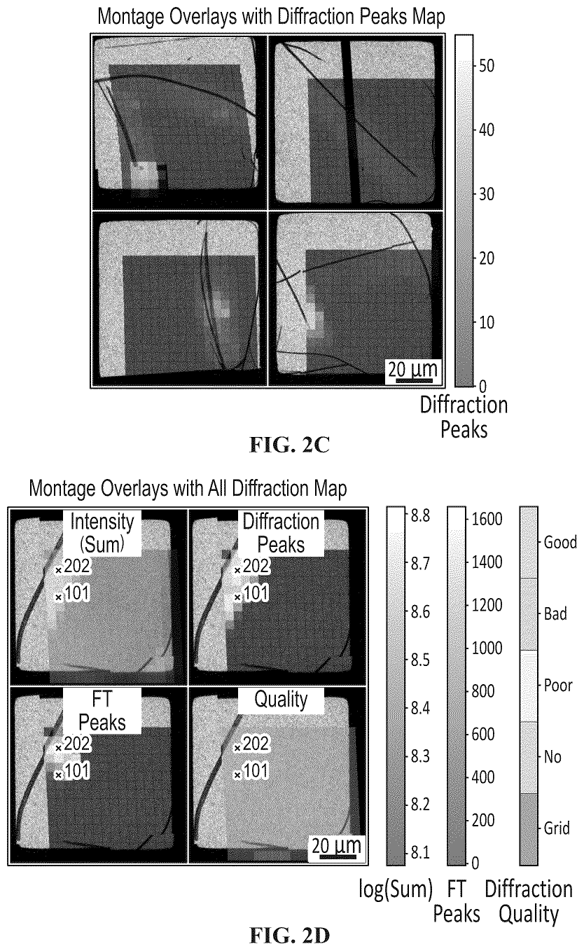

To facilitate autonomous data collection, the REyes pipeline was installed and calibrated on four TEMs equipped with field emission guns, two or more condenser lenses, and various scintillator-based or direct electron detectors. After REyes installation and microscope calibration for data acquisition, following sample insertion, a singular command triggers a fully automated sequence. It commences with the SerialEM-driven acquisition of an initial imaging atlas at low magnification (~150×), enabling subsequent processing stages. Grid squares are identified on this atlas using a segmentation algorithm, locating grid squares with both low and high particle densities (FIG. 2A). This information is communicated to the microscope, which adjusts the eucentric height for all grid squares using an eucentric plane regression with only five selected points (FIG. 2B).

Once all areas of interest have been delineated, the microscope enters diffraction mode, and REyes spatially maps diffraction from designated areas on the grid, generating a map of that signal while conducting on-the-fly data analysis through the REyes monitoring system. Each pixel within this map corresponds to precise x, y, and z coordinates, which links to sample diffraction data and metrics. Signal filtering applied to diffraction images enables real-time detection and counting of diffraction peaks in each pattern.

A map of the number of detected diffraction peaks overlaid onto the real-space image of the scanned grid area indicates a good correlation between the positions of crystals and observed diffraction (FIG. 2C). The total diffraction intensity of each pattern is also captured, which again correlates with the diffraction peaks map (FIG. 2D). However, lattice disorder and sample polycrystallinity can limit the utility of these maps for effective autonomous collection of high-quality datasets.

Increased robustness in high quality crystallite selection is attained by further analysis of the measured diffraction patterns using a peakpicking algorithm in Patterson space. It was found the number of peaks in Patterson space directly correlates with crystallite lattice quality, as previously indicated in analyses of lattice defects and disorder. REyes applies this Patterson-based lattice quality analysis to binarized diffraction images. REyes combines diffraction intensity, number of diffraction peaks, and Patterson-informed lattice quality to classify every diffraction image and generate a diffraction quality atlas. Pixels exhibiting high-quality diffraction are then selected as targets for further analysis, guiding serial crystallography or single crystal continuous rotation electron diffraction acquisition (FIG. 2D).

This approach allows for imaging directly in diffraction space, which enhances throughput while prioritizing high-quality data collection. Because microscope time is often limited and diffraction is not an intrinsic property of all materials, visual particle identification offers limited utility in MicroED workflows. The presently disclosed methods minimize time spent on visual mapping, typically devoting less than 30 minutes per grid to real-space imaging. Real-space imaging may be performed to create a visual representation of the sample that is suitable for interpretation by the user; however it is not essential for the success of the diffraction quality classification. Real-space imaging may additionally be performed to identify discrete areas of the sample grid suitable for containing crystals. As the microscope scans the grid in diffraction mode, a background algorithm classifies frames in real-time according to diffraction quality metrics, including pixel intensity, diffraction peak count, and the peak arrangement in a 2D Fourier transform (FT), giving preference to frames with a high Patterson peak count. Upon completion of diffraction imaging, a ranked target list is autonomously compiled by REyes, highlighting regions of high-quality diffraction. This list can be customized based on quality thresholds to support targeted data acquisition. REyes directs the microscope to acquire tilt-series data over a specified angular range, typically ±50°, targeting ~1° wedges per frame. With the latest hardware and counting detectors, a single tilt series could be collected under 60 seconds.

Spatially-Aware microED Automation. Identifying crystals directly in diffraction space provides immediate feedback on diffraction quality, but introduces a key challenge: redundancy. Because many crystals exceed the size of the electron beam, diffraction mapping without spatial context can lead to repeated acquisition from adjacent regions of the same large crystal, wasting microscope time and reducing data diversity. In contrast, computer vision helps to avoid redundancy but offers no information on diffraction quality across a crystal. To address these limitations, we implemented spatial awareness in REyes. By tracking the coordinates of all identified targets and enforcing a minimum spacing between acquisitions (typically ~10 μm), REyes ensures that data are collected from distinct crystallites. This spatially informed diffraction mapping increases throughput, reduces redundancy, and improves sampling across the grid.

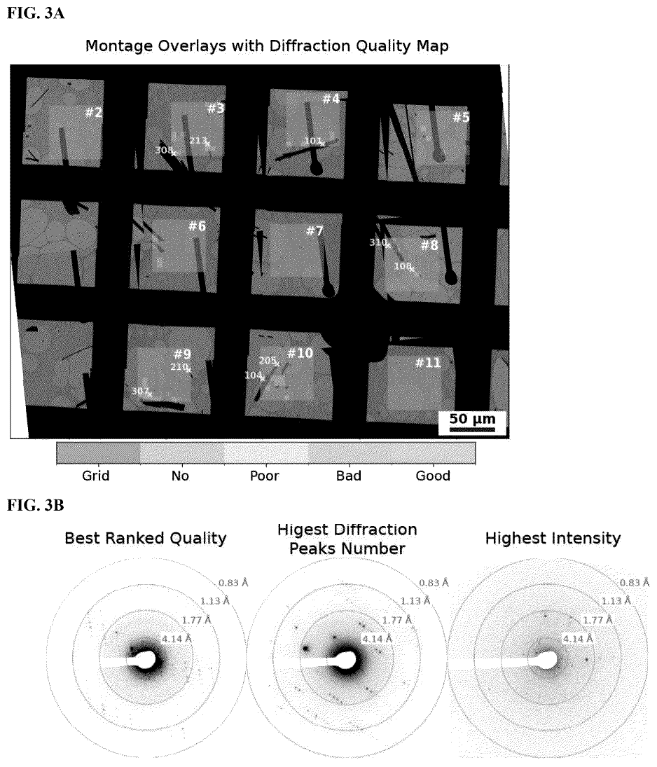

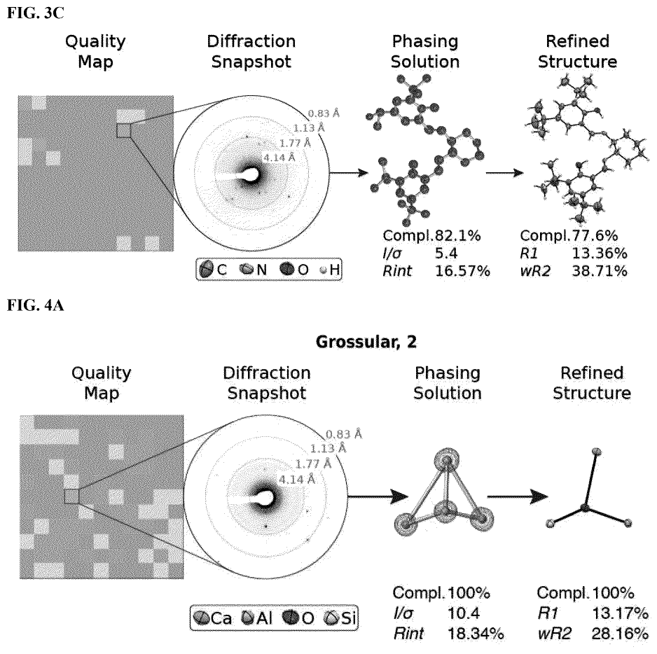

To test spatial awareness in REyes, spatially aware REyes development was initiated using the (S,S)-salen ligand (1). It was hypothesized that diffraction mapping within a narrow region (±200 μm from the stage origin) would typically be sufficient to determine a crystal structure. In this area, REyes identified 10 candidate locations (FIG. 3A) and completed diffraction mapping within 2.3 hours from initialization. The target list was curated to include the three best regions based on: i) overall diffraction quality; ii) number of diffraction peaks; and iii) total frame-sum intensity. Each was selected with full spatial context to minimize overlap and ensure sampling of distinct crystals. This strategy, which incorporates three ranking criteria and spatial separation, effectively mitigates target bias (FIG. 3B).

As anticipated for (S,S)-salen ligand (1), all prioritized targets exhibited distinct, high-quality diffraction patterns, surpassing 1.0 Å resolution. REyes autonomously acquired all 9 datasets using an Apollo direct electron camera in less than 30 min at 1°/s rotation rate. Because REyes is integrated with the AutoProcess package, each acquired dataset underwent on-the-fly autonomous processing using XDS. AutoProcess is initiated at the conclusion of each tilt-series. Of nine continuous rotation movies (±50° range) (Table 1), seven were successfully indexed to the anticipated unit cell and space group, one indexed to the expected dimensions in a lower symmetry space group (Table 1, entry 8), and only one movie failed to yield the expected unit cell (Table 1, entry 3). On average, the indexing statistics reflected high quality diffraction, with average I/σ=5.3 and CC½=81% including unsuccessful datasets; all selected targets were classified as “Good”.

Following acquisition and indexing, all datasets were subjected to automatic phasing, using SHELXT and SHELXD, referred to as AutoSolve. Target 213, identified in grid square #8 (FIG. 3C), with the highest completeness at 82.1% (Table 1, entry 6), yielded an ab initio phasing solution at 0.8 Å from a single movie. A preliminary solution generated by SHELXD correctly elucidated the molecular structure and was manually kinematically refined (FIG. 3C). The same grid was next analyzed using an Arctica/CETA-D microscope/camera configuration at cryogenic temperature and 0.12°/s rotation rate. The installation and adjustment of REyes-specific processing parameters for this purpose required less than 2 hours. This approach revealed a new list of targets, from which a new target 104 also resulted in a single-movie solution.

By default, REyes collects 9 continuous rotation datasets, however, tilt series data completeness ultimately depends on crystal space group and orientation on the grid, which are not a priori knowledge. In this example, a single movie solution has been obtained from the 3^{rd} dataset from Arctica/CETA-D system. The other 8 datasets could be merged to yield a high-quality structure as well. For example, without using target 104 data we have successfully merged targets 103, 208, and 214, which produced an 82.7% complete solution with I/σ=3.9, Rint=37.10%, and CC½=96.7%.

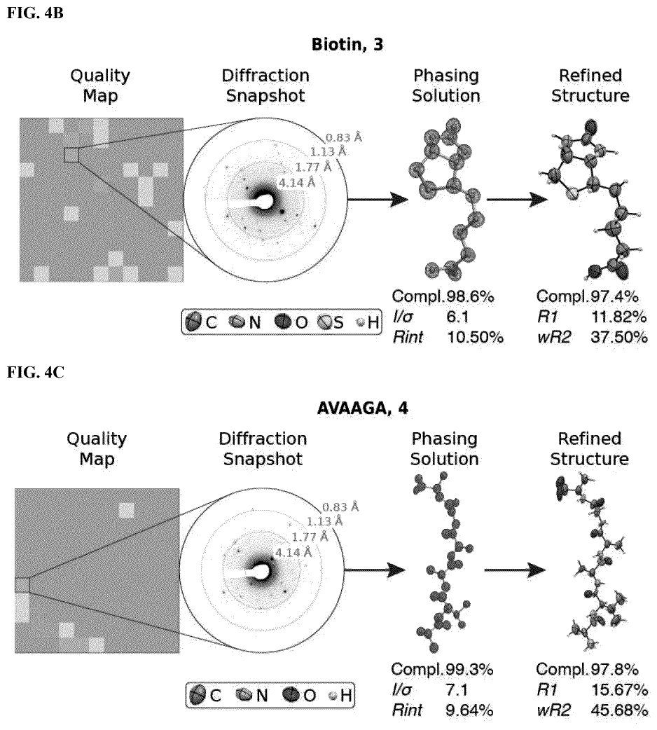

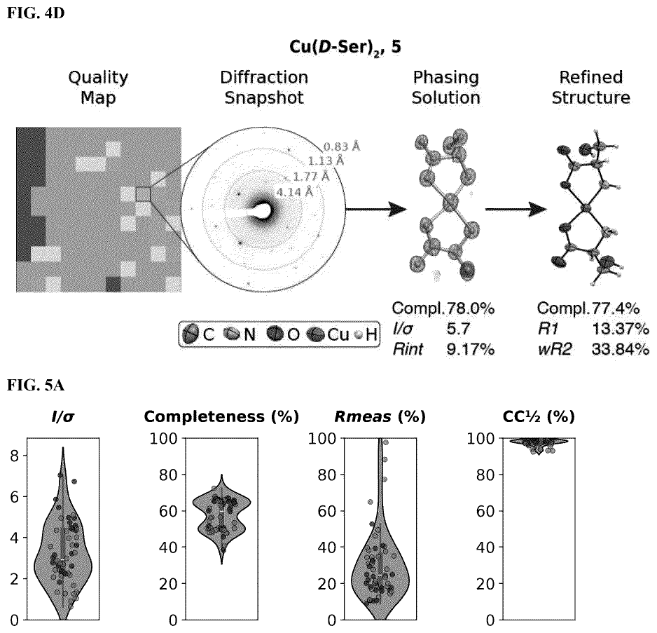

To benchmark the broader utility of a fully autonomous REyes pipeline, four more crystalline structures were examined: the beam-insensitive mineral grossular (2), vitamin B7 (biotin, 3) with moderate beam sensitivity, a beam-sensitive peptide, AVAAGA (4), and the highly beam-sensitive Cu(D-Ser)₂ complex (5). All four samples were first analyzed under identical settings at room temperature using the F200C/Apollo microscope/camera configuration. Each molecular structure was autonomously solved ab initio from a single movie (FIG. 4).

Grossular lacks uniformly crystalline particles, which typically requires numerous hours for manual surveying. In contrast, REyes surveyed the grid and collected nine high-quality tilt series within 3 h. When applied to biotin (3) this pipeline identified multiple crystallites classified as “Good” diffraction. REyes yielded a dataset with 98.6% completeness that phased ab initio, with 97.4% completeness after refinement, with an I/σ of 6.1.

The hexapeptide AVAAGA (4) and Cu(D-Ser)₂ complex (5) are challenging for acquisition at room temperature due to their beam sensitivity. REyes efficiently delivered single-movie solutions in under three hours (FIG. 4). The best AVAAGA peptide dataset was 97.8% complete after refinement with an I/σ of 7.1. The most challenging sample studied at room temperature was the Cu(D-Ser)₂ complex (5). Despite its high beam sensitivity, REyes obtained a single movie solution from a 77.4% complete dataset after refinement and an I/σ of 5.7.

The same samples, analyzed at cryogenic temperatures with an Arctica/CETA-D system, also yielded the expected structural outcomes. While the slower rotation rate and lower sensitivity of the CETA-D, increased both sample surveying and tilt series acquisition times, the REyes approach was successful on this cost effective and widely available detector. All 5 samples, (S,S)-salen ligand (1), grossular (2), biotin (3), AVAAGA peptide (4), and Cu(D-Ser)₂ complex (5) were successfully measured, with each compound producing a single movie solution in 6 hours. The longer acquisition time was primarily due to a slower rotation rate (0.12°/s for CETA-D vs. 1°/s for Apollo) during tilt series data collection. The beam-sensitive Cu(D-Ser)₂ complex (5), however, suffered radiation damage during slow, yet cryogenic, data collection, limiting achievable completeness to only 66.7% (77.4% with Apollo detector). The best structural model was obtained by refining against an analogous model from the Apollo data collected at room temperature. This underscores the importance of low-dose, high-speed acquisition strategies for beam-sensitive materials, where rapid data collection could significantly improve data quality even at room temperature, compared to cryogenic, yet slow acquisition.

The REyes pipeline was further demonstrated on two 300 kV microscopes: a Tecnai TF-30/TVIPS, and a Spectra 300C/CETA-D. REyes installation and optimization of diffraction processing parameters required less than 2 h, yielding a system ready for fully autonomous data acquisition. Using (S,S)-salen ligand (1) as a reference sample, each instrument autonomously collected 9 movies of comparable data quality to those obtained on 200 kV microscopes.

Next, REyes was put to the test, evaluating its ability to determine the structure of a complex NP: citrinovirin (6), isolated from Trichoderma citrinoviride and characterized by microED. The sample was deposited onto a TEM grid and autonomously analyzed with REyes operating the Arctica/CETA-D system. One of 9 continuous rotation datasets, collected within 6 h, provided a solution with 98.4% completeness.

REyes' ability to autonomously detect NPs was next gauged in a crude extract of the commercial cactus believed to belong to the genus Echinopsis. Despite their broad geographic distribution and existing applications, cacti remain underexplored. The crude extract containing visible particulates was directly applied onto a TEM grid. REyes was deployed to screen a 1 mm² area of the grid using an Arctica/Apollo. REyes autonomously and continuously screened 68 grid squares, captured 8228 diffraction snapshots, and acquired 60 continuous rotation datasets (1°/s over a ±50° range) from the most promising crystalline targets, all in less than 21 hours without human intervention. These datasets were processed on-the-fly using the integrated AutoProcess and AutoSolve pipelines, resulting in 22 preliminary ab initio phasing solutions.

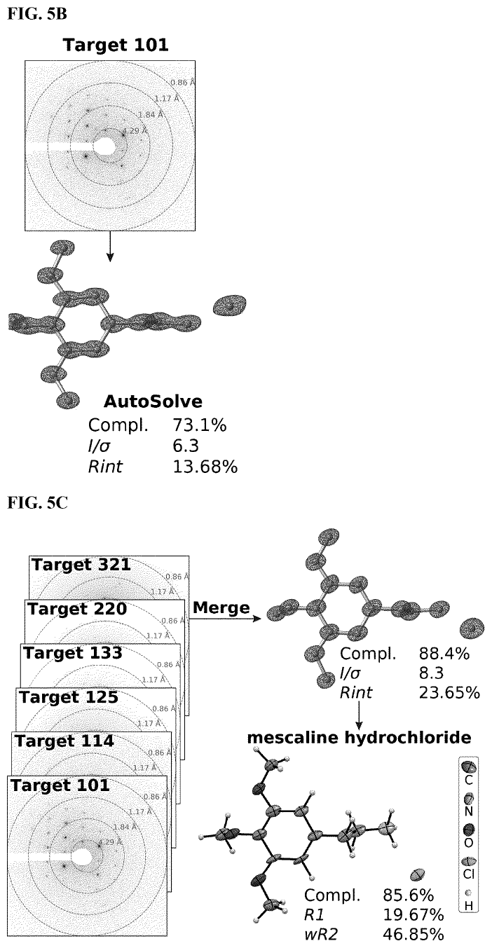

Unexpectedly, 43 of the 54 datasets corresponded to the same unit cell: a=38.6±0.8 Å, b=5.13±0.02 Å, c=12.87±0.05 Å, α=90°, β=104.5±0.9, γ=90°. From these, the 34 highest-quality datasets exhibited I/σ ranging from 2 to 5, completeness between −40-70%, Rmeas values from 14-41%, and CC½ values above 93% (FIG. 5B). The remaining 10 of the 11 corresponded to the reduced unit cell parameters of the same crystal system and they led to the structurally identical phasing solution. Last dataset lacked sufficient quality to support meaningful structural interpretation.

Among the successfully phased datasets, crystal target 101 yielded the highest quality abinitio solution in space group C2/c, revealing a molecular framework consistent with a 3,4,5-trimethoxyphenethyl core, a hallmark of the mescaline alkaloid family (FIG. 5C). To improve completeness, six datasets were merged using crystal 101 as a reference, although preferred particle orientation on the grid limited the final 88.4% completeness (FIG. 5D). Initial phasing indicated a solution in a monoclinic space group C2/c, and structure refinement ultimately yielded a solution consistent with mescaline hydrochloride (7).

The potential presence of mescaline protoalkaloids in the Echinopsis genus has been previously reported. Liquid chromatography high-resolution mass spectrometry (LC-HRMS) analysis of the crude extract revealed several features with m/z values corresponding to mescaline analogues. Accordingly, the proposed structure of alkaloid 7 underscores the transformative potential of REyes as a self-driving microED platform for structure elucidation of natural products in mixtures.

The ability of REyes to classify diffraction was evaluated with two datasets acquired on the F200C/Apollo: (S,S)-salen ligand (1) and biotin (3). Classification follows precise numerical thresholds applied through Gaussian filters for peak detection and FT pattern quality analysis, adjusted to each microscope/camera pair. These thresholds are determined upon REyes installation (<2 h total time). In addition, the central 25% of each image is masked during peak detection, ensuring that “Good” class reflects high-resolution features of diffraction pattern rather than low-resolution signal.

REyes prioritizes precision over recall for high-quality samples, achieving Cohen's Kappa coefficients of 0.68 and 0.64 across the two datasets. This result aligns with practical MicroED acquisition goals, where it is more critical to avoid missing high-quality targets than to exclude poor ones. Misclassifying a “Good” diffraction pattern as “Bad” results in loss of valuable data, as these targets are never acquired. In contrast, if a “Bad” pattern is misclassified as “Good,” it could still be included in the list of targets, but typically lower ranked due to fewer Patterson peaks and is unlikely to be selected for acquisition.

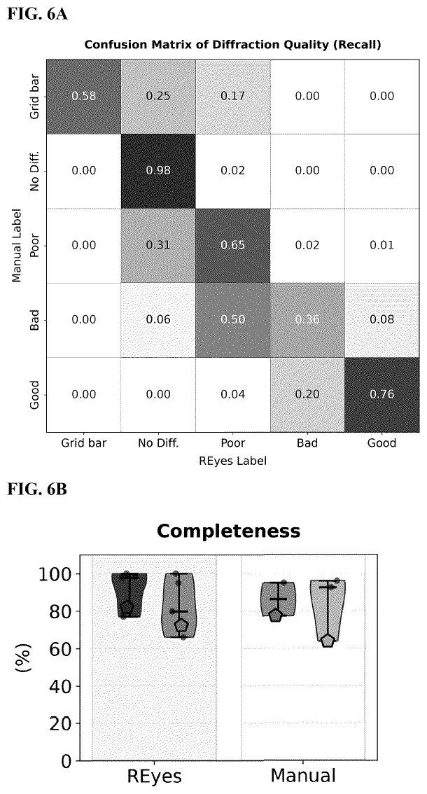

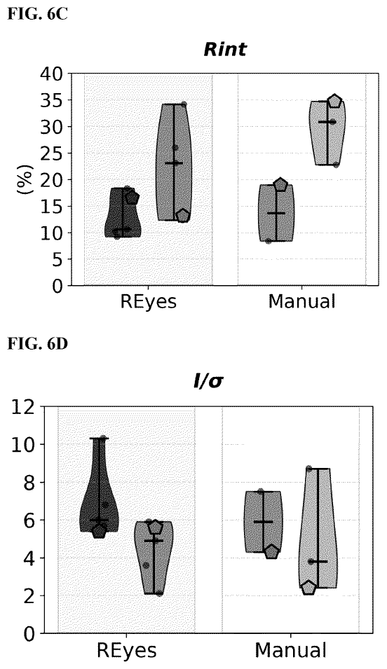

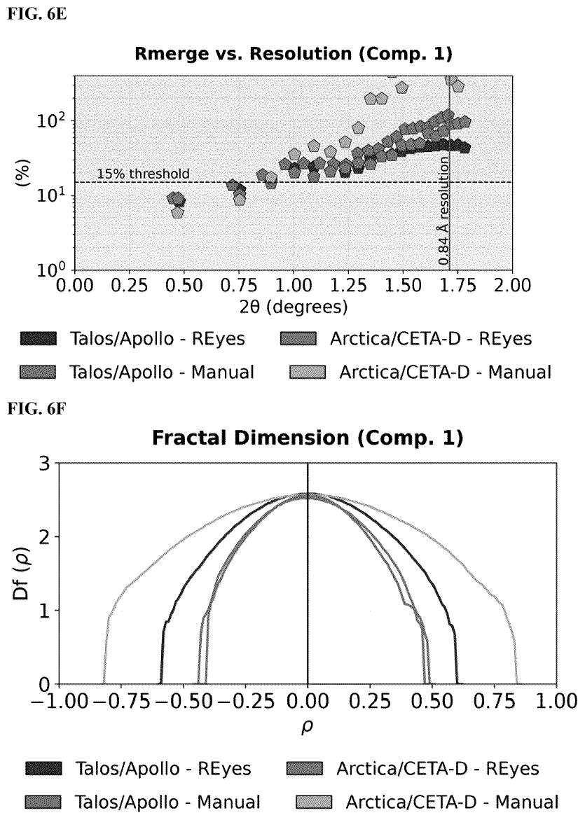

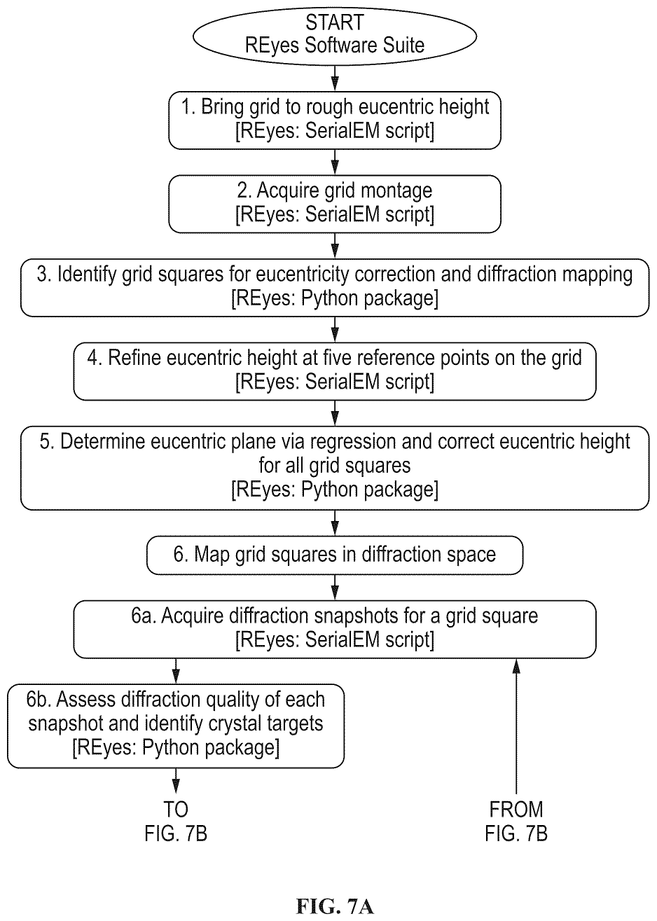

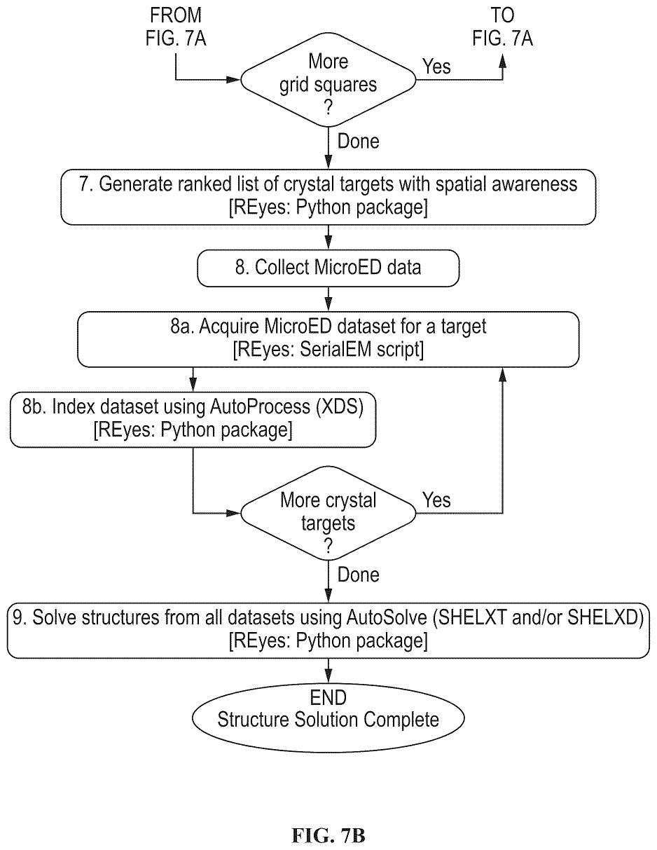

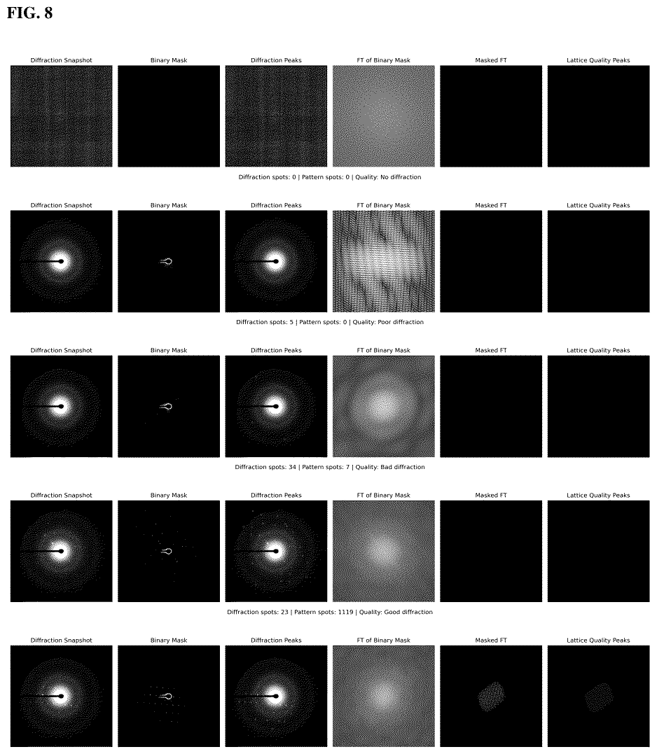

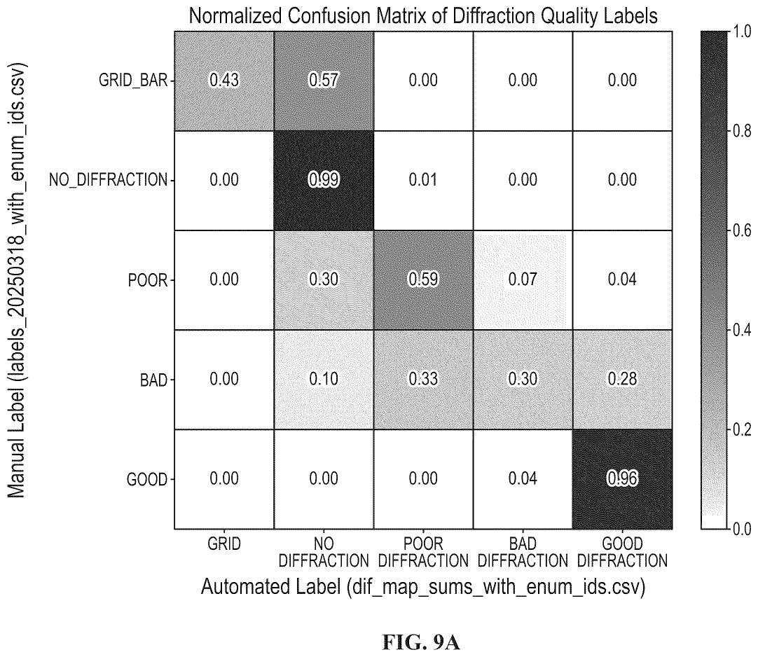

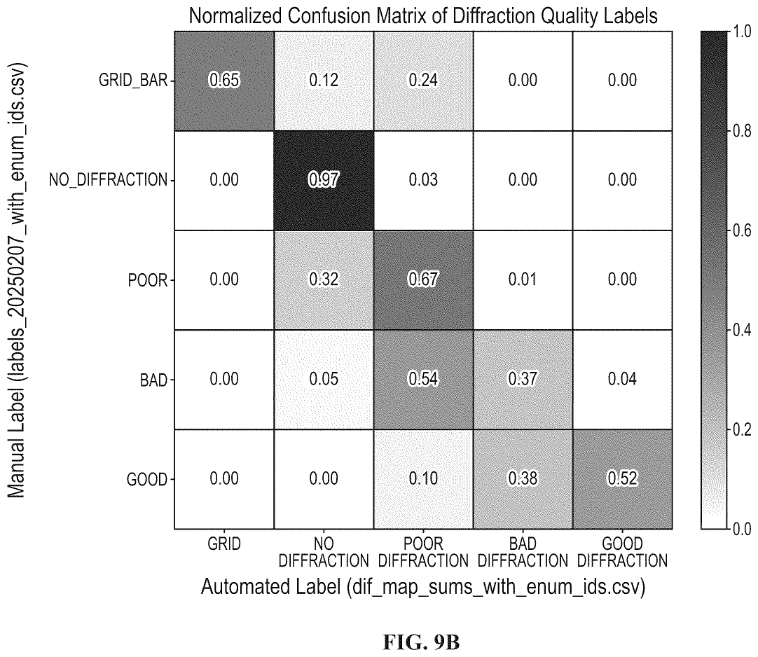

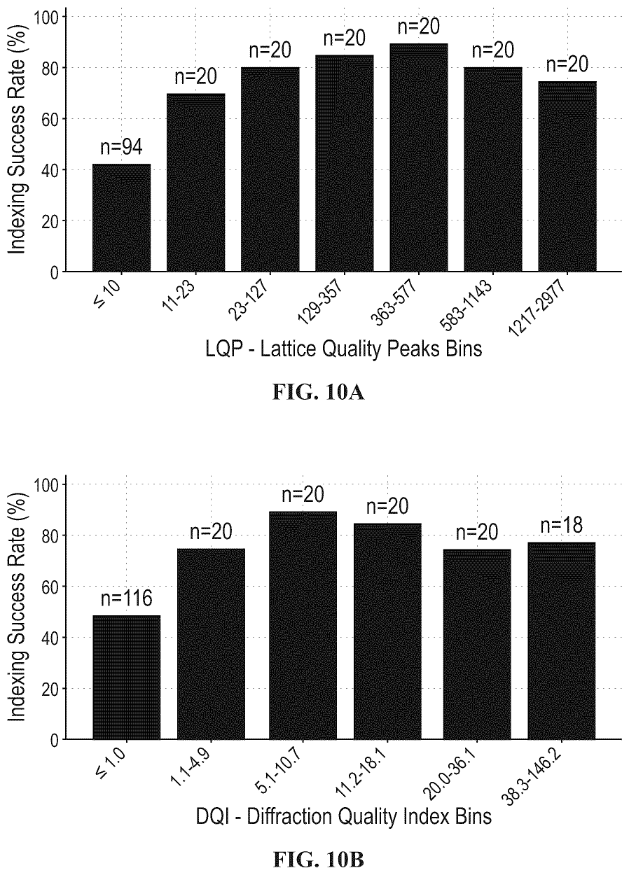

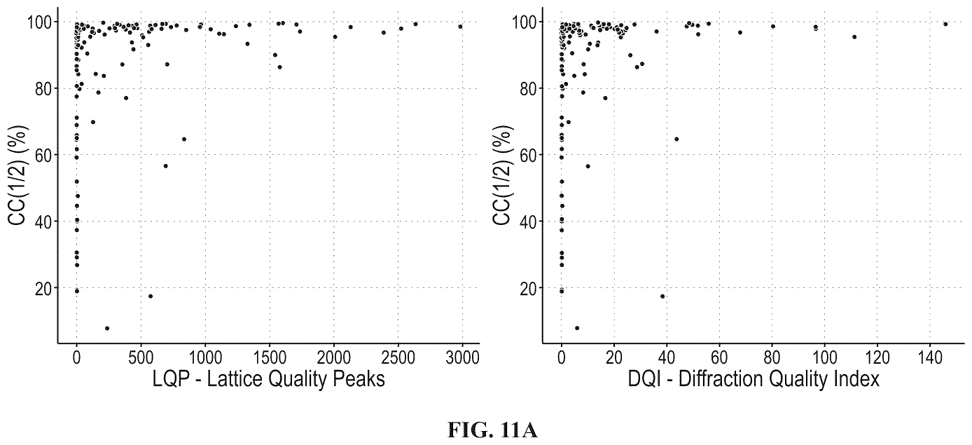

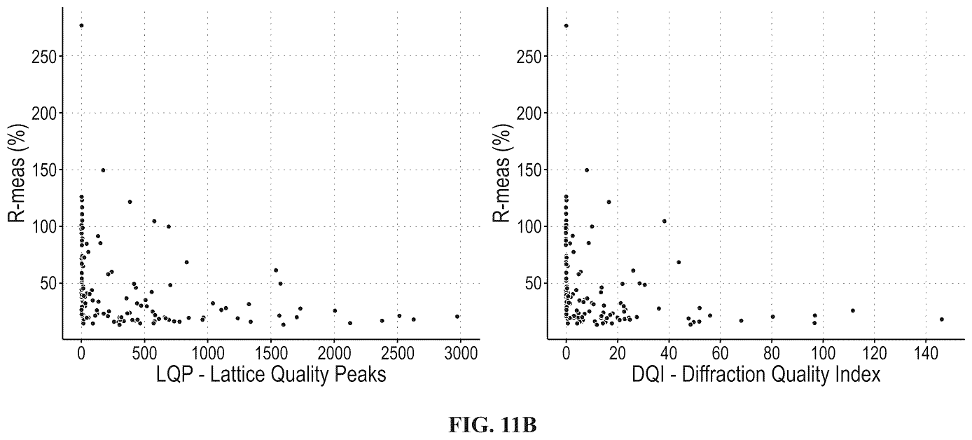

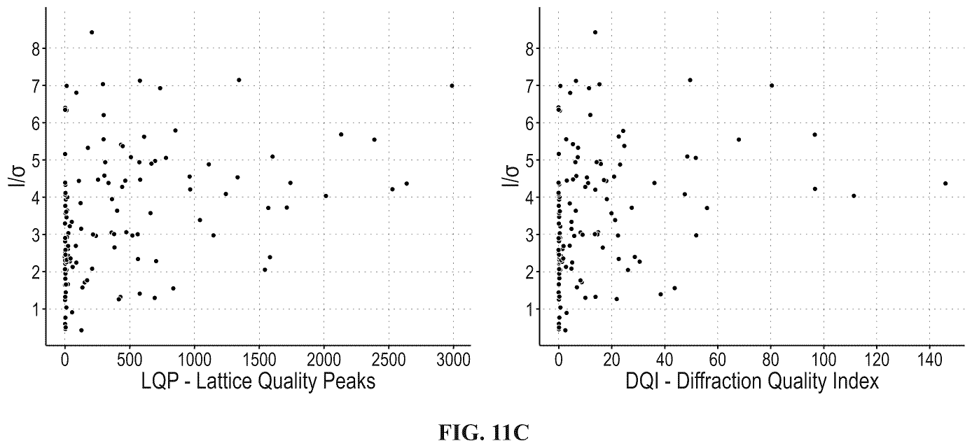

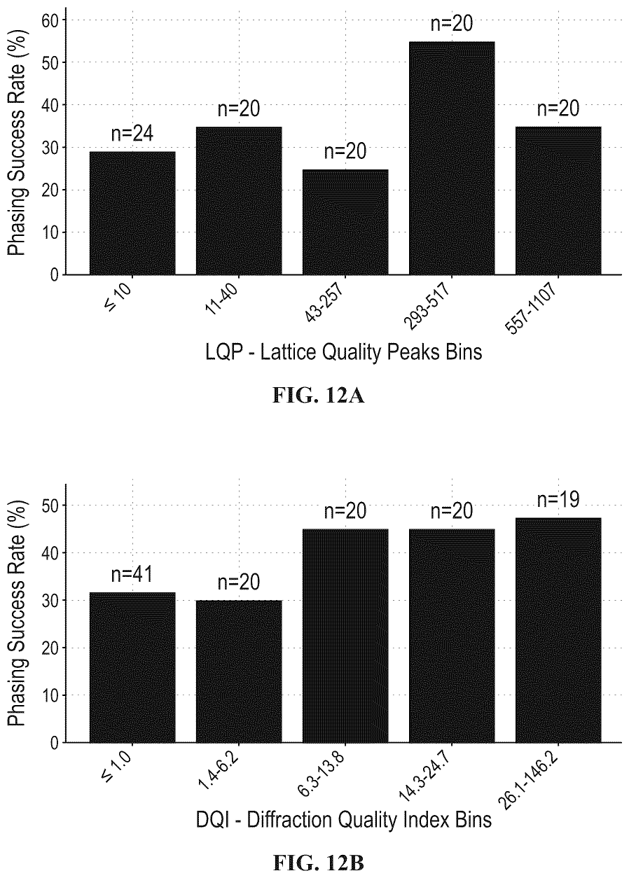

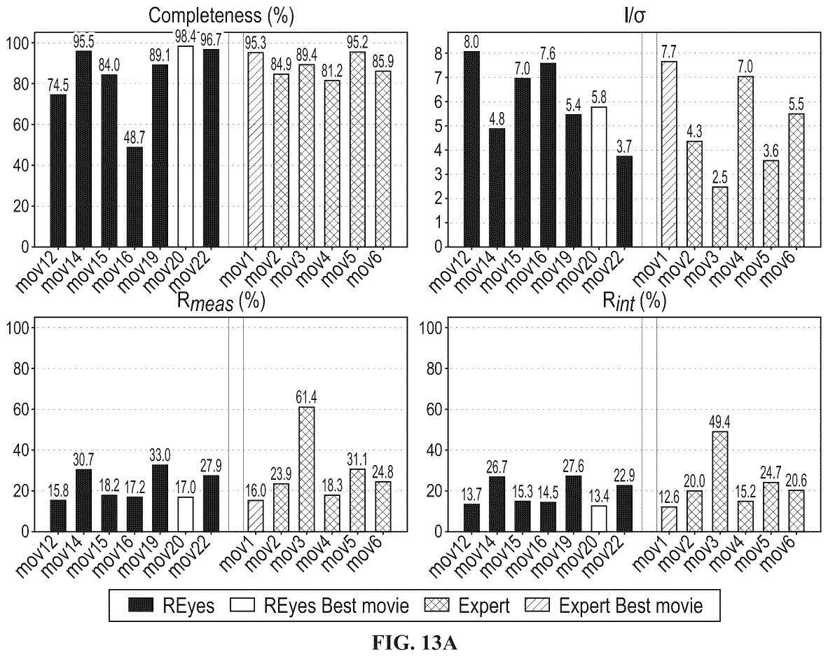

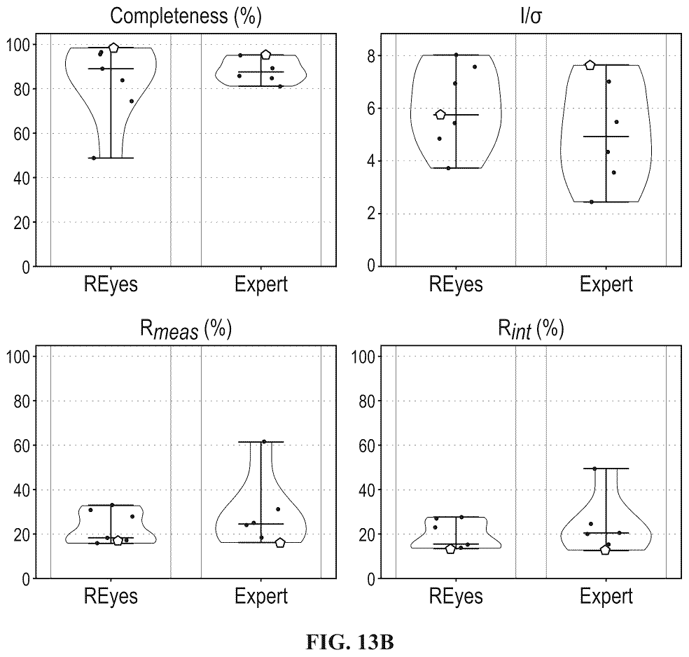

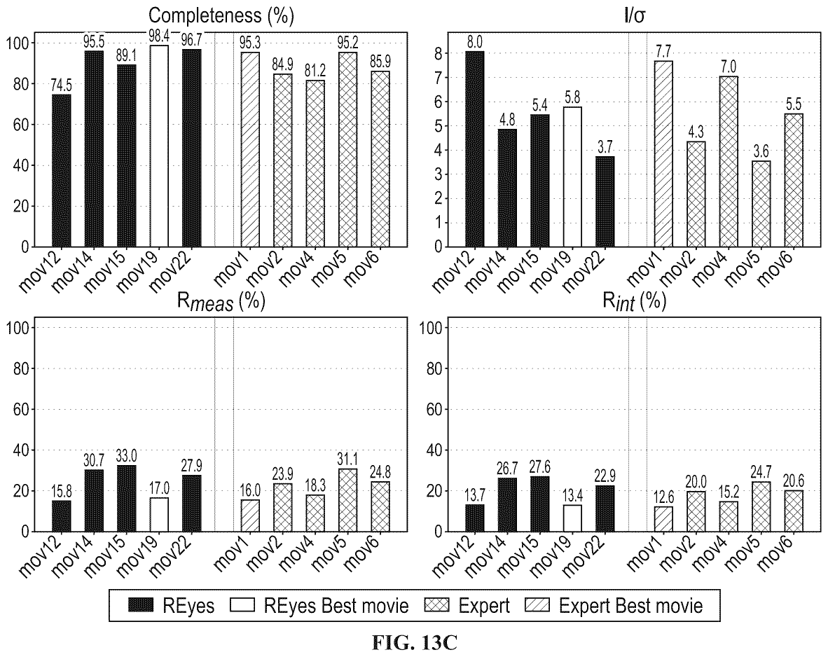

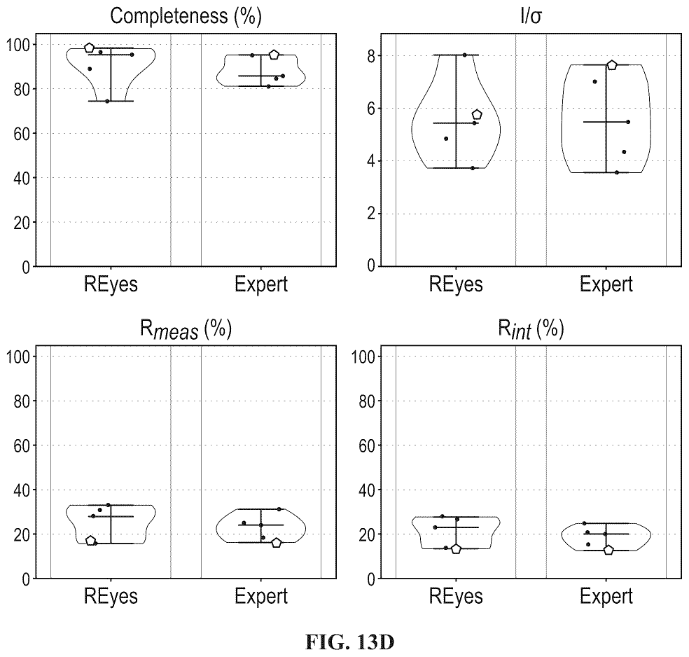

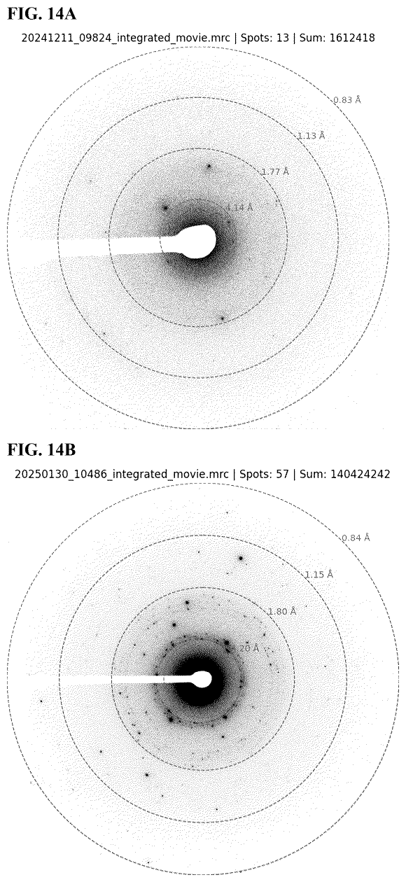

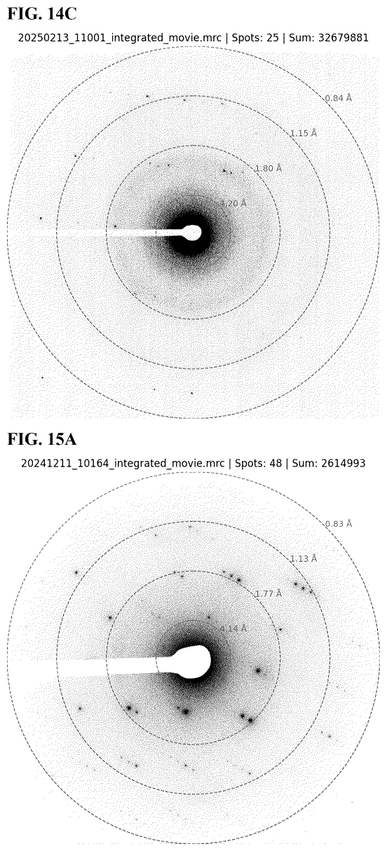

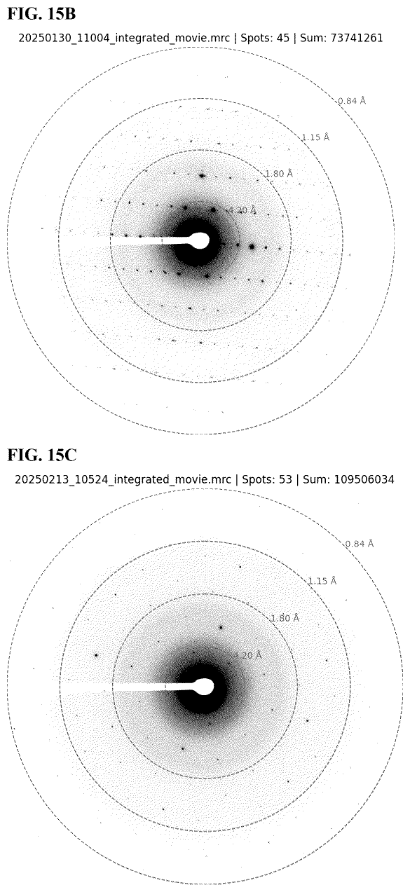

Since only top-ranked targets are pursued, this design favors confident selection of high-quality data while tolerating a limited number of low-impact false positives. Similar principles are well established in diagnostic science and imbalanced classification literature, where the cost of overlooking true positives often outweighs the inclusion of occasional false positives. The normalized combined confusion matrix reveals that most misclassifications occur between adjacent quality categories, with only 8% of images (18 out of 223) manually labeled as “Bad” were classified as “Good” (FIG. 6A).

The biggest classification challenge occurs for “Poor” and “Bad” categories. For the (S,S)-salen ligand (1) dataset over half of manually labeled “Bad” samples are classified as “Poor”. Since both categories are likely to represent suboptimal lattices, this approach prioritizes processing efficiency at the expense of tolerating an observed classification overlap. The substantial class imbalance caused by the overpopulated “No diffraction” category, representing 91.8% and 76.1% of respective datasets, is explained by the intentional relative sparsity of grids. This favors the diffraction of isolated particles with confidence, since the developed model effectively identifies images in the “No diffraction” category (F1 scores of 0.99 and 0.97). REyes applies this rubric across all samples, independent of the intrinsic quality of crystallite in the sample, ensuring comparable autonomous microED data collection.

By favoring confident identification of high-quality patterns and minimizing the risk of overlooking them, REyes ensures efficient and reproducible data collection across diverse samples. This enables consistent microED performance even in sparse or challenging grids, without requiring expert oversight.

Failure of ab initio structure determination from a single continuous rotation movie with resolution higher than 1.0-1.2 Å is typically due to insufficient completeness of diffraction data. The performance of REyes was assessed in both high and low completeness regimes and importantly compared its performance to that of microED practitioners. Data quality and structural outcomes were compared for datasets acquired using REyes or manually collected by a human operator on both a CETAD and Apollo direct electron detectors under comparable conditions (FIGS. 6B-6D). The violin plots comparing data for benchmarking samples suggest an unbiased advantage in using REyes.

Assessing data collected from (S,S)-salen ligand (1) as a representative system, REyes data from the Apollo detector achieved 5-10% higher completeness relative to their manually collected counterparts (FIG. 6B). This is surprising, given that, in principle, completeness is primarily determined by crystal orientation and should be independent of the data acquisition workflow. The difference likely stems from more comprehensive grid coverage achieved with REyes and the unbiased diffraction quality-driven target selection strategy, compared to the more biased, human effort of visual particle targeting.

The internal consistency of data, as measured by the internal consistency of equivalent reflections R factor (Rint), provides a metric for data reliability. Datasets acquired with REyes showed a 3-18% reduction in Rint compared to manually collected data (FIG. 6C). This enhancement is also subject to the unbiased selection of diffraction features by REyes, rather than the human selection of particles in real space. REyes data was also notably better in its signal-to-noise ratio, with I/σ values 2-4 units higher than those obtained from manual acquisition (FIG. 6D). Merging R factors (Rmerge) were also assessed across datasets, and lower Rmerge values were found across REyes datasets. This underscores the robustness of diffraction classification and autonomous target selection compared to conventional manual workflows (FIG. 6E).

Lastly, the quality of determined structures were assessed by examining residual electron density distributions using fractal dimension analysis. In all four test cases, residual maps approximated Gaussian distributions, consistent with unbiased structural models. A REyes dataset acquired using a CETA-D camera produced steeper fractal plots, indicative of higher model fidelity (FIG. 6F). These results demonstrate that REyes not only accelerates data acquisition but also enables consistency and reproducibility, while maintaining and often enhancing the quality of microED data, compared to manual acquisition.

In conclusion, REyes introduces a fully autonomous, diffraction-guided workflow for microED data acquisition that eliminates the need for human intervention from target identification through structural solution. By leveraging real-time diffraction mapping and sample-independent classification, REyes ensures the selective targeting of high-quality crystalline data. The performance of the system was validated across chemically and structurally diverse compounds, with all structures solved ab initio from single datasets, demonstrating both speed and precision. The diffraction classification model ensures robust decision-making and efficient use of instrument time, even for challenging or beam-sensitive samples. This work lays the foundation for scalable, fully self-driving molecular structure elucidation, unlocking new possibilities in discovery of materials, biomolecules and pharmaceuticals.

### Methods for Electron Diffraction Imaging

The present disclosure relates to methods for the structural determination of chemical compounds using electron diffraction data acquisition and data processing. In some cases, the methods described herein may allow for fully automated microcrystal electron diffraction (microED) data collection through diffraction-based sample mapping and automated target selection. Human intervention may be eliminated from the data acquisition process, spanning from sample insertion through structure determination.

The methods described herein may address limitations of conventional approaches by providing a diffraction-driven automation workflow. In some cases, the workflow may shift from imaging mode to diffraction mode for navigation and target selection. A diffraction atlas may be generated for navigation purposes, and decision-making during data acquisition may be automated based on diffraction properties. The approach may reduce inefficiencies and improve data quality by selectively targeting high-quality diffraction data.

In some cases, the methods disclosed herein may incorporate autonomous, real-time diffraction data analysis. Sample-independent diffraction classification may be performed to assess diffraction quality regardless of sample type. Spatial awareness may be maintained to prevent overexposure of any area of a transmission electron microscopy (TEM) grid. The workflow may proceed from data acquisition through fully indexed, merged, and phased datasets without human input.

The autonomous data acquisition approach described herein may eliminate the need for real-space imaging to identify particles, as diffraction is not an inherent property of any material. Instead, diffraction space may be assessed based on diffraction quality, and data collection may be limited to high-quality or desired-quality diffraction data. The collected data may be compatible with existing downstream data analysis approaches, including serial crystallography, step-wise selected tilt series, or continuous rotation tilt movie analysis.

Sample preparation for electron diffraction data acquisition may be performed using grids having any mesh configuration. In some cases, 200 mesh Cu grids may be used as a substrate for sample deposition. The grids may include a film coating to support the sample material. Lacey Carbon or Quantifoil film coatings may be applied to the grids. Alternatively, Formvar/Carbon layered film coatings may be applied to the grids. The film coating may provide a support structure for crystalline samples while allowing electron transmission through the grid openings.

Sample deposition onto the grids may be accomplished through various methods. In some cases, a dry deposition method may be employed. The grids may be placed in a dram vial containing a quantity of compound material. Approximately 1 mg of compound may be placed in the dram vial with the grids. The dram vial may then be shaken lightly to distribute the compound material onto the grid surface. The shaking action may cause particles of the compound to adhere to the film coating of the grid.

In some cases, a wet deposition method may be employed for sample preparation. A volume of crystal slurry may be deposited onto the grids. Approximately 2 microliters of crystal slurry may be deposited onto the grid surface. Following deposition, residual liquid may be removed from the grid. Filter paper may be used to carefully remove residual water or solvent from the grid after a waiting period. The waiting period may allow crystals to settle onto the grid surface before liquid removal.

Sample deposition onto the grid may be accomplished from a solution of a substance or a mixture of substances of interest. The solution may be transferred onto the grid and crystals may be grown on the grid from this solution. The residual liquid may be evaporated, removed with fibrous material such as filter paper or washed away by another liquid.

Sample arraying onto grids may be performed using ArrayED technology. ArrayED technology may enable high-throughput on-grid liquid deposition. In some cases, ArrayED technology may facilitate crystallization directly on the grid surface. Solutions containing sample material may be arrayed onto the grid in a controlled manner using ArrayED technology. The arraying process may produce an ordered distribution of sample material across the grid surface. ArrayED technology may be employed for samples prepared from solutions, such as solutions containing dissolved compounds in solvent mixtures.

Substances and materials of known chemical composition and 3-dimensional atomic structure may be added onto the prepared grid at any stage of the sample preparation. These additives may be, but not limited to known crystalline organic materials, crystalline hard materials, nanoparticles, or fiducial particles, or any kind or porous matrix.

After the preparation of a grid, samples may be dry, may remain hydrated, may be frozen. The crystals on the prepared grids that may require hydration or solvation, may be but not limited to proteins, nucleic acids, and complexes thereof, may be subject to vitrification using manual or automated vitrification methods at the temperature of liquid ethane as a cryogen. Inert atmosphere or atmosphere of any chemical composition may be used for the prepared grids. Liquid samples may be used, where liquid phase containing the sample is protected from the vacuum environment of the electron microscope.

The prepared grids may be transferred to a sample holder or autoloader of a transmission electron microscope. In some cases, the transfer may be performed under ambient or anaerobic conditions. The transfer may or may not be performed under cryogenic conditions using liquid nitrogen as a cryogen. No additional experimental setup may be required beyond the sample preparation steps described above. The grid configuration and sample preparation methods may be compatible with both room temperature and cryogenic data collection conditions.

The methods described herein may be implemented using transmission electron microscopes operating at different accelerating voltages. In some cases, a transmission electron microscope may operate at 200 keV, corresponding to an electron wavelength of 0.0251 Angstroms. In some cases, a transmission electron microscope may operate at 300 keV, corresponding to an electron wavelength of 0.0197 Angstroms or 120 keV corresponding to an electron wavelength of 0.0335 Angstroms. The selection of accelerating voltage may depend on the sample characteristics and desired data quality parameters and the energy of the electron beam may not be limited to one. The electron beam may be attenuated to achieve appropriate flux of electrons. The attenuation of the beam may be established prior to the acquisition or may be adjusted in response to the quality of acquired data. The samples may be subject to analysis using multiple beam attenuation factors. These attenuation factors may be called spot size or beam intensity, or spot intensity, or probe current, or beam current.

The methods may be compatible with multiple detector types for image acquisition. In some cases, a Direct Electron Apollo camera may be used, the Direct Electron Apollo camera having a maximum resolution of 8192×8192 pixels. In some cases, a CETA-D camera may be used, the CETA-D camera having a maximum resolution of 4096×4096 pixels. In some cases, a TVIPS TemCam-XF416 CMOS camera may be used, the TVIPS TemCam-XF416 CMOS camera having a maximum resolution of 4096×4096 pixels. The detector selection may be based on the microscope platform and data acquisition requirements.

Images may be recorded using different binning factors depending on the detector and microscope configuration. In some cases, images may be recorded using 2x binning. In some cases, images may be recorded using 4x binning. The binning factor may affect the effective pixel size and data file size while maintaining sufficient resolution for diffraction data analysis.

The camera length may be calibrated to yield a target resolution at the frame edge across different microscope and detector configurations. In some cases, the camera length may be calibrated to yield approximately 0.8 Angstrom resolution at the frame edge. The calibrated camera length may vary depending on the specific microscope and detector combination while maintaining the target resolution at the frame edge.

The microscope may be configured with a standardized aperture configuration across different microscope platforms. In some cases, a 50 micrometer C2 aperture may be installed in the microscope. In some cases, a 70 micrometer objective aperture may be installed in the microscope. The aperture configuration may control beam characteristics and diffraction pattern quality.

The beam may be focused at a back focal plane of an objective lens to produce a near-parallel beam configuration. The back focal plane may be assumed to be coplanar with the objective aperture. The near-parallel beam configuration may be verified prior to data collection by adjusting the C2 lens current to produce a beam of specified width at a target C2 lens current percentage.

The methods may operate at both room temperature and cryogenic temperatures. In some cases, a room temperature sample holder may be used for data acquisition. In some cases, cryogenic temperatures may be employed for data acquisition. In some cases, the cryogenic temperature may be 80 Kelvin. An Autoloader may be used to maintain cryogenic temperatures during sample loading and data acquisition. The temperature selection may depend on sample sensitivity to beam exposure and thermal stability requirements.

An imaging atlas may be acquired at low magnification to facilitate downstream data processing and analysis. The imaging atlas may comprise a grid montage that captures the entire grid surface or a portion thereof. The imaging atlas may be acquired using an imaging mode of the transmission electron microscope. In some cases, the imaging mode may be configured at a low magnification setting, such as LM 155×, LM 210×, LM 280×, or LM 205×, depending on the microscope platform. The low magnification setting may enable visualization of multiple grid squares within a single field of view or through montage assembly.

Following acquisition of the imaging atlas, the imaging atlas may be automatically processed to identify regions for further data acquisition. A segmentation algorithm may be applied to the imaging atlas to identify grid squares on the imaging atlas. The segmentation algorithm may be configured to accommodate both low and high particle densities on the grid surface. In some cases, the segmentation algorithm may detect grid square boundaries based on contrast differences between the grid bars and the grid square openings. The segmentation algorithm may generate a list of grid square positions corresponding to stage coordinates for subsequent processing steps.

The grid square identification process may be performed numerically without human intervention. The segmentation algorithm may analyze pixel intensity distributions within the imaging atlas to distinguish grid squares from surrounding grid bar structures. In some cases, the segmentation algorithm may apply thresholding operations to generate a binary representation of grid square locations. The segmentation algorithm may further apply morphological operations to refine the identified grid square boundaries.

The identified grid squares may be evaluated for suitability for further data acquisition. In some cases, grid squares that are partially obscured, damaged, or located at the grid periphery may be excluded from subsequent processing. The segmentation algorithm may output a set of grid square coordinates that define the spatial extent for diffraction mapping operations. The grid square coordinates may be communicated to the microscope control system to guide subsequent eucentric height adjustment and diffraction mapping procedures.

Eucentric height determination may be performed following identification of grid squares on the imaging atlas. The eucentric height may be adjusted to position the sample at the eucentric plane of the microscope stage, where tilting the stage does not result in lateral displacement of the sample within the field of view. Proper eucentric height adjustment may facilitate accurate data collection during tilt series acquisition by maintaining the target position centered throughout the tilt range.

The eucentric height may be determined using eucentric plane regression with five selected reference points on the grid. The five reference points may be distributed across the grid surface to sample the spatial variation in eucentric height across the grid. In some cases, the five reference points may be selected from among the identified grid squares to provide coverage of different regions of the grid. The selection of five reference points may balance the need for accurate eucentric plane determination against the time required for eucentric height measurement at each reference point.

At each of the five selected reference points, the eucentric height may be measured using an imaging mode of the transmission electron microscope. The eucentric height measurement at each reference point may involve tilting the stage and adjusting the z-height until lateral displacement of the sample is minimized. The measured eucentric height values at the five reference points may be recorded along with the corresponding stage x and y coordinates.

Following measurement of the eucentric height at the five selected reference points, eucentric plane regression may be performed to determine the eucentric plane across the grid. The eucentric plane regression may fit a plane to the five measured eucentric height values based on the corresponding stage coordinates. The regression may account for any tilt or inclination of the grid relative to the stage plane. The resulting eucentric plane may define the z-height as a function of x and y stage coordinates across the grid surface.

The eucentric height for all identified grid squares may be corrected based on the eucentric plane determined through regression. For each grid square, the eucentric height may be calculated from the eucentric plane equation using the stage coordinates of the grid square. The calculated eucentric height values may be stored for use during subsequent diffraction mapping and data acquisition operations. The eucentric height correction may be applied automatically without human intervention, enabling the microscope to maintain proper eucentric positioning as the stage moves between grid squares during data acquisition.

Following eucentric height correction for all identified grid squares, the microscope may be switched to diffraction mode to perform diffraction mapping across the grid. In diffraction mode, the microscope may acquire diffraction snapshots at multiple stage coordinates corresponding to positions within the identified grid squares. The diffraction mapping process may generate a map in reciprocal space, where each pixel within the map correlates with precise x, y, and z stage coordinates and encapsulates diffraction information pertaining to the sample at that location.

The diffraction mapping may be performed by moving the stage or beam across the sample in a systematic manner. In some cases, the stage may be moved in a step-wise fashion between discrete positions for diffraction snapshot acquisition. In some cases, the stage may be moved in a continuous motion while diffraction snapshots are acquired at regular intervals. In some cases, the beam may be moved across the sample while the stage remains stationary. The movement pattern may be configured to provide coverage of the grid squares identified during the imaging atlas processing step.

At each stage coordinate during diffraction mapping, a diffraction snapshot may be acquired using the detector. The diffraction snapshot may capture the diffraction pattern produced by the sample material at that location. The diffraction snapshot may be stored as a data file containing pixel intensity values representing the diffraction pattern. The exposure time for diffraction mapping may be configured based on the detector and microscope platform. In some cases, the exposure time for diffraction mapping may be 0.25 seconds, 0.5 seconds, or 1 second.

Data processing may be performed on-the-fly during diffraction mapping through a monitoring system. The on-the-fly processing may analyze each diffraction snapshot as the diffraction snapshot is acquired, enabling real-time assessment of diffraction quality across the grid. The on-the-fly processing may occur concurrently with continued diffraction snapshot acquisition, such that data analysis does not delay the mapping process. The time required for on-the-fly processing may depend on available computational resources.

MicroED movies acquired during tilt series data collection may be processed on-the-fly using AutoProcess 2.0 software. The AutoProcess 2.0 software may convert data using an mrc2tif file converter. During conversion, a pedestal value of 1 may be uniformly added to every frame of the data. The addition of the pedestal value may prevent negative pixel values that could arise during subsequent processing operations. Following conversion with the mrc2tif file converter, the converted TIF images may be processed using an XDS or DIALS or other packages designed to process diffraction data. The XDS or any used package may perform indexing and integration of the diffraction data to determine unit cell parameters and space group information.

The on-the-fly processing pipeline may enable immediate feedback regarding data quality as tilt series are acquired. The AutoProcess 2.0 software may be initiated when a tilt series concludes, enabling rapid assessment of whether the acquired data can be successfully indexed.

The indexing results from the XDS package may be used to evaluate data quality and inform subsequent target selection decisions. The on-the-fly processing may eliminate delays between data acquisition and data quality assessment that would otherwise occur with batch processing approaches.

Data collection may only include acquisition of 2-dimensional diffraction snapshots without sample rotation to obtain MicroED movies, or using beam precession. After Data may be serial and serial crystallography data processing methods may be applied.

The diffraction quality classification system may categorize diffraction patterns into five distinct classes based on numerical thresholds. The five classes may comprise Grid, No Diffraction, Poor Diffraction, Bad Diffraction, and Good Diffraction. Each diffraction snapshot acquired during diffraction mapping may be assigned to one of the five classes based on analysis of the diffraction pattern characteristics.

The classification may be performed using Gaussian filters for peak detection. The Gaussian filters may be applied to the diffraction snapshot to identify diffraction peaks within the image. The Gaussian filter parameters may be tailored to each microscope-camera pair to account for differences in detector characteristics and optical configurations. The Gaussian filters may suppress noise while preserving diffraction peak features for subsequent counting and analysis.

Fourier Transform pattern quality analysis may be performed as part of the classification process. A two-dimensional Fourier Transform may be applied to a binary representation of the diffraction pattern. The number of peaks detected in the Fourier Transform image may reflect the quality and periodicity of the crystal lattice that produced the observed diffraction pattern. Higher numbers of Fourier Transform peaks may indicate better quality crystal lattice structure. The Fourier Transform analysis may distinguish between single crystal diffraction patterns exhibiting periodic lattice structure and polycrystalline or amorphous patterns lacking such periodicity.

The classification system may mask a central portion of each diffraction image during peak detection. In some cases, the central 25% of each diffraction image may be masked during peak detection operations. The central masking may ensure that Good classification reflects high-resolution features of the diffraction pattern rather than low-resolution signal concentrated near the beam center. The central masking may exclude the direct beam and low-resolution reflections from the peak counting analysis, thereby focusing the classification on the presence of high-resolution diffraction features.

A minimum diffraction peak threshold may be applied to determine whether a diffraction snapshot is considered for further analysis. In some cases, frames may be required to have greater than 10 diffraction peaks to be considered for further analysis. Frames having 10 or fewer diffraction peaks may be classified as Poor Diffraction. The minimum diffraction peak threshold may serve as an initial filter to exclude diffraction snapshots that lack sufficient diffraction information for successful data processing.

The Grid class may be assigned to diffraction snapshots acquired at positions corresponding to grid bar structures rather than grid square openings. The Grid class may be identified based on characteristic intensity patterns associated with electron scattering from the metallic grid bar material. The No Diffraction class may be assigned to diffraction snapshots that lack detectable diffraction peaks above the background noise level. The No Diffraction class may correspond to positions on the grid where no crystalline material is present or where the sample material is amorphous.

The Poor Diffraction class may be assigned to diffraction snapshots having fewer than about 10 diffraction peaks. The Poor Diffraction class may be identified through the minimum diffraction peak threshold without requiring additional Fourier Transform analysis. The early classification of Poor Diffraction patterns may improve processing efficiency by avoiding computational overhead associated with Fourier Transform analysis for low-quality patterns.

The Bad Diffraction class may be assigned to diffraction snapshots having greater than about 10 diffraction peaks but exhibiting characteristics inconsistent with high-quality single crystal diffraction. In some cases, the Bad Diffraction class may correspond to polycrystalline diffraction patterns where multiple crystal orientations contribute to the observed diffraction. The Bad Diffraction class may be distinguished from the Good Diffraction class based on the number and arrangement of peaks in the Fourier Transform image.

The Good Diffraction class may be assigned to diffraction snapshots exhibiting characteristics consistent with high-quality single crystal diffraction. The Good Diffraction class may be characterized by greater than about 10 diffraction peaks and a high number of peaks in the Fourier Transform image. The Good Diffraction classification may indicate that the corresponding stage position contains a crystal suitable for tilt series data acquisition. Positions classified as Good Diffraction may be prioritized for subsequent continuous rotation data collection.

Patterson space analysis may be employed to assess crystallite lattice quality for target selection during diffraction mapping. Patterson space, also referred to as Patterson function space, represents the autocorrelation function of the electron density distribution within a crystal structure. The Patterson function may be computed from the squared magnitudes of the structure factors, which correspond to the intensities of the diffraction peaks observed in a diffraction pattern. Patterson space analysis may provide information regarding interatomic vector distributions within the crystal lattice without requiring phase information.

The number of peaks detected in Patterson space may correlate with the quality of the crystallite lattice. A well-ordered crystallite lattice may produce a Patterson function exhibiting a greater number of distinct peaks corresponding to interatomic vectors within the unit cell. Conversely, a disordered or poorly diffracting crystallite may produce a Patterson function with fewer distinguishable peaks due to reduced periodicity and increased disorder within the lattice structure. The correlation between Patterson space peak count and lattice quality may enable quantitative assessment of crystallite suitability for data collection.

Patterson space analysis may be integrated into the target selection process during diffraction mapping. For each diffraction snapshot classified as exhibiting diffraction, the Patterson function may be computed from the observed diffraction intensities. The number of peaks in the resulting Patterson space representation may be counted using peak detection algorithms. Diffraction snapshots exhibiting higher numbers of Patterson space peaks may be assigned higher priority for subsequent tilt series data acquisition, as the higher Patterson space peak count may indicate superior crystallite lattice quality.

The Patterson space peak count may serve as a complementary metric to the Fourier Transform analysis described above. While the Fourier Transform of the binary diffraction peak mask may assess the periodicity of the diffraction pattern itself, the Patterson space analysis may assess the underlying structural order within the crystallite. The combination of Fourier Transform pattern analysis and Patterson space analysis may provide a more comprehensive evaluation of diffraction quality and crystallite suitability for structure determination. Target selection may be improved through incorporation of Patterson space peak count as a factor in ranking potential data collection targets.

The diffraction mapping process may generate multiple overlay maps for visualization and target selection purposes. The overlay maps may be generated from the diffraction snapshots acquired during the diffraction mapping procedure and may be spatially registered to the imaging atlas acquired at low magnification. Each overlay map may represent a different characteristic of the diffraction data extracted from the diffraction snapshots at each stage coordinate position.

A Diffraction Quality map may be generated to visualize the spatial distribution of diffraction quality classifications across the grid. The Diffraction Quality map may display the classification assigned to each diffraction snapshot position, with different visual representations corresponding to the Grid, No Diffraction, Poor Diffraction, Bad Diffraction, and Good Diffraction classes. The Diffraction Quality map may be overlaid with the imaging atlas to correlate diffraction quality with the visual appearance of the sample in imaging mode. The Diffraction Quality map may enable identification of regions containing high-quality diffracting crystals suitable for tilt series data acquisition.

A Diffraction Intensity map may be generated to visualize the spatial distribution of diffraction intensity across the grid. The Diffraction Intensity map may represent the integrated intensity or sum intensity of each diffraction snapshot at the corresponding stage coordinate position. The Diffraction Intensity map may be displayed using a color scale or grayscale representation where higher intensity values correspond to stronger diffraction signal. The Diffraction Intensity map may correlate with the presence of crystalline material and the thickness or scattering power of the sample at each position.

A Diffraction Peaks map may be generated to visualize the spatial distribution of the number of detected diffraction peaks across the grid. The Diffraction Peaks map may represent the count of diffraction peaks identified in each diffraction snapshot following application of the Gaussian filters and peak detection algorithms. The Diffraction Peaks map may be displayed using a color scale or grayscale representation where higher peak counts correspond to positions exhibiting more diffraction features. The Diffraction Peaks map may correlate with the positions and orientations of crystals on the grid, as crystalline regions may produce diffraction snapshots containing greater numbers of detectable peaks.

A Fourier Peaks map may be generated to visualize the spatial distribution of the number of peaks detected in the Fourier Transform images across the grid. The Fourier Peaks map may represent the count of peaks identified in the Fourier Transform of the binary diffraction peak mask for each diffraction snapshot. The Fourier Peaks map may be displayed using a color scale or grayscale representation where higher Fourier Transform peak counts correspond to positions exhibiting greater lattice periodicity and quality. The Fourier Peaks map may provide information regarding the crystalline order at each position, as well-ordered single crystals may produce Fourier Transform images with greater numbers of distinct peaks.

The multiple overlay maps may be used in combination for target selection during the autonomous data acquisition workflow. The Diffraction Quality map, Diffraction Intensity map, Diffraction Peaks map, and Fourier Peaks map may each provide complementary information regarding the suitability of each position for tilt series data collection. Target selection algorithms may incorporate information from multiple overlay maps to rank potential data collection targets based on multiple criteria. The overlay maps may be stored for subsequent review and analysis following completion of the data acquisition session.

Target selection may be performed following completion of the diffraction mapping process to identify positions suitable for tilt series data acquisition. The target selection process may incorporate spatial awareness constraints to ensure that data is collected from distinct crystallites across the grid surface. A minimum spacing constraint may be enforced between acquisition targets to reduce redundancy in the collected data and to prevent multiple datasets from being acquired from the same crystallite or from overlapping regions of the sample.

The minimum spacing between acquisitions may be approximately 10 micrometers. The 10-micrometer spacing constraint may ensure that each selected target corresponds to a distinct crystallite rather than an adjacent region of a previously selected crystallite. The spacing constraint may be applied during target list generation such that any candidate target position located within approximately 10 micrometers of a previously selected target may be excluded from the target list. The enforcement of the minimum spacing constraint may reduce the likelihood of collecting redundant datasets from the same crystal while maximizing the diversity of crystallites sampled during the data acquisition session.

A multi-criteria target selection approach may be employed to curate the target list for tilt series data acquisition. The multi-criteria approach may incorporate information from multiple characteristics of the diffraction data to select targets exhibiting favorable properties across different metrics. The multi-criteria approach may reduce bias that could arise from selection based on a single criterion and may increase the likelihood of acquiring datasets suitable for structure determination.

The target list may be curated to include targets selected from three categories based on different diffraction characteristics. A first category may comprise targets selected based on overall diffraction quality as determined by the diffraction quality classification system. A second category may comprise targets selected based on the number of diffraction peaks detected in the diffraction snapshot. A third category may comprise targets selected based on total frame-sum intensity of the diffraction snapshot. The three categories may provide complementary selection criteria that together identify targets exhibiting high-quality diffraction characteristics.

The top three targets from each of the three categories may be included in the curated target list. The selection of the top three targets from each category may result in a target list containing up to nine targets when all selected targets are distinct. In some cases, a target may rank among the top three in multiple categories, in which case the target may be included in the target list once and additional targets may be selected to maintain the target count. The identity and spatial awareness constraints may be applied during target selection to ensure no redundancy in the target list and to maintain the minimum spacing between any two selected targets.

The methods may comprise collecting about nine continuous rotation datasets per grid analysis session. The about nine datasets may correspond to the targets selected through the multi-criteria target selection approach described above. The collection of about nine datasets may provide sufficient data for structure determination while limiting the total acquisition time and electron dose delivered to the sample. The collection number may be modified based on user preferences or sample characteristics, but the nine dataset default may represent a balance between data completeness and acquisition efficiency for typical microED data collection sessions.

Following target selection, tilt series data acquisition may be performed at each selected target position to collect continuous rotation electron diffraction data. The tilt series may be collected by rotating the microscope stage through a defined angular range while continuously acquiring diffraction frames. The continuous rotation approach may enable sampling of reciprocal space as the crystal rotates through different orientations relative to the electron beam.

The tilt series may be collected spanning a range from about +50 degrees to about −50 degrees, covering a total tilt range of about 100 degrees. The about +50 degree to about −50 degree range may provide sufficient angular coverage to sample a substantial portion of reciprocal space for most crystal systems. The symmetric tilt range about zero degrees may balance data collection across positive and negative tilt angles. The about 100 degree total tilt range may enable determination of unit cell parameters and space group information from the acquired diffraction data.

The rotation rate during tilt series acquisition may be varied depending on the detector type employed for data collection. In some cases, the rotation rate may be about 1 degree per second. In some cases, the rotation rate may be about 0.3 degrees per second. In some cases, the rotation rate may be about 0.5 degrees per second. The selection of rotation rate may be based on the readout speed and sensitivity characteristics of the detector, as well as the desired angular sampling density within the tilt series.

When a Direct Electron Apollo camera is employed for data acquisition, the rotation rate may be about 1 degree per second. The about 1 degree per second rotation rate may be compatible with the fast readout capabilities of direct electron detectors. The faster rotation rate may reduce total acquisition time for each tilt series while maintaining sufficient signal-to-noise ratio in the acquired diffraction frames.

When a CETA-D camera is employed for data acquisition, the rotation rate may be about 0.3 degrees per second. The about 0.3 degree per second rotation rate may accommodate the readout characteristics of the CETA-D detector. The slower rotation rate may provide longer integration time per angular increment, which may compensate for differences in detector sensitivity compared to direct electron detectors.

When a TVIPS TemCam-XF416 CMOS camera is employed for data acquisition, the rotation rate may be about 0.5 degrees per second. The about 0.5 degree per second rotation rate may represent an intermediate value suited to the characteristics of the TVIPS detector. The rotation rate selection for each detector type may be configured during system setup to optimize data quality for the specific microscope and detector combination.

Tilt movies may be acquired at about a 1 second exposure time during tilt series data collection. The about 1 second exposure time may be applied across different microscope and detector configurations. The exposure time may determine the electron dose delivered per frame and the signal-to-noise ratio of the acquired diffraction data. The combination of rotation rate and exposure time may determine the angular range sampled within each acquired frame of the tilt series.

Following acquisition and on-the-fly processing of continuous rotation microED data, automated structure determination may be performed to solve crystal structures from the acquired datasets. The automated structure determination process may be referred to as AutoSolve. The AutoSolve process may be initiated after all continuous rotation microED data have been collected and processed through the AutoProcess pipeline. The AutoSolve process may enable structure determination without human intervention, completing the autonomous workflow from sample insertion through preliminary structure solution.

The data collected from the refence known materials added to the sample may be used to correct or to improve data quality. The refence materials may be used but are not limited to for the calibration of the crystal target positioning while the microscope is acquiring data in the diffraction mode, or for the correction of experimental distortions imposed by the focusing of the electron beam, such distortions may result in fluctuations of the detector distance parameter used for data processing, or to ascertain the absolute configuration of the molecules.

Structures may be solved ab initio by direct methods using SHELXT and SHELXD software packages. Direct methods may enable structure solution from diffraction data without requiring prior knowledge of the molecular structure or isomorphous replacement experiments. The SHELXT software package may be employed for ab initio phasing of the diffraction data. The SHELXD software package may also be employed for ab initio phasing of the diffraction data. In some cases, both SHELXT and SHELXD may be applied to the same dataset, and the solution exhibiting superior quality metrics may be selected for subsequent refinement.

The direct methods approach implemented in SHELXT and SHELXD may exploit statistical relationships among structure factor phases to determine an initial set of phases for the observed diffraction intensities. The initial phases may be combined with the observed diffraction amplitudes to compute an electron density map. The electron density map may be interpreted to identify atomic positions within the unit cell. The preliminary solution generated by SHELXT or SHELXD may correctly elucidate the molecular structure in cases where the diffraction data quality is sufficient for successful phasing.

Following ab initio phasing, the preliminary structure solution may be selected for further refinement. In some cases, multiple datasets acquired during the autonomous data acquisition session may yield successful ab initio solutions. The solution exhibiting the highest quality metrics may be selected from among the successful solutions for subsequent refinement. The selection process may be performed automatically based on crystallographic quality indicators such as R-factors, completeness, and resolution.

Structure refinement may be performed using SHELXL and olex.refine software packages. The SHELXL software package may be employed for least-squares refinement of atomic coordinates and thermal parameters against the observed diffraction data. The olex.refine software package may also be employed for structure refinement. In some cases, refinement may be performed using Olex2 software, which may incorporate both SHELXL and olex.refine refinement engines. The refinement process may iteratively adjust atomic parameters to minimize the difference between observed and calculated structure factors.

Electron scattering factors may be incorporated during structure refinement. Electron scattering factors may differ from X-ray scattering factors due to the different physical interactions between electrons and matter compared to X-rays and matter. The use of electron scattering factors may be appropriate for refinement of structures determined from electron diffraction data. The electron scattering factors may be applied within the SHELXL and olex.refine refinement procedures to account for the electron diffraction origin of the data.

Thermal parameters may be refined anisotropically for all non-hydrogen atoms during structure refinement. Anisotropic thermal parameters may describe the directional dependence of atomic displacement from the mean position. Anisotropic refinement may employ six independent parameters per atom to describe the thermal motion ellipsoid, compared to a single isotropic thermal parameter. The anisotropic refinement of thermal parameters for all non-hydrogen atoms may provide a more accurate description of atomic displacement and may improve the agreement between observed and calculated structure factors.

Hydrogen atoms may be assigned using a riding model during structure refinement. The riding model may position hydrogen atoms at geometrically calculated positions relative to their parent atoms. The hydrogen atom positions may be updated during refinement to maintain the geometric relationship with the parent atom positions. The riding model approach may reduce the number of independent parameters refined while providing reasonable hydrogen atom positions for the refined structure.

In some cases, a single continuous rotation dataset acquired from a single crystal target may provide sufficient completeness for successful structure determination through ab initio phasing and refinement. However, in some cases, a single movie solution may be insufficient to achieve the completeness required for structure determination. When single movie solutions are insufficient, multiple datasets acquired from different crystal targets may be merged to improve completeness of the diffraction data.

The merging of multiple datasets may combine diffraction observations from different crystal orientations to sample a greater portion of reciprocal space than would be accessible from any single crystal. Each crystal target selected during the target selection process may present a different orientation relative to the electron beam, and the tilt series acquired from each crystal target may sample a different region of reciprocal space. The combination of observations from multiple crystal targets through merging may increase the fraction of unique reflections measured within the resolution limit of the data.

The multi-dataset merging capability may be employed when the completeness achieved from individual datasets is below a threshold required for successful structure solution. In some cases, individual datasets may exhibit completeness values that are insufficient for ab initio phasing by direct methods. The merging of two or more datasets from different crystal targets may increase the overall completeness to a level sufficient for structure determination. The merged dataset may contain observations of reflections that were not sampled in any single constituent dataset due to the limited tilt range or the particular orientation of each individual crystal.

The datasets selected for merging may be required to index to compatible unit cell parameters and space group assignments. The AutoProcess pipeline may determine unit cell parameters and space group information for each acquired dataset through indexing with the XDS package. Datasets exhibiting consistent unit cell dimensions and space group symmetry may be identified as candidates for merging. Datasets that index to incompatible unit cells or different space groups may represent different polymorphs or different compounds and may be excluded from the merging process.

The merging process may scale and combine the integrated intensities from multiple datasets to produce a single merged dataset. The scaling process may account for differences in overall intensity scale between datasets arising from variations in crystal size, beam intensity, or detector response. The merged intensities may be computed as weighted averages of the scaled observations from the constituent datasets. The merged dataset may then be subjected to ab initio phasing and structure refinement using the same procedures applied to single-dataset solutions.

The diffraction quality classification system may achieve classification accuracy consistent with manual labeling by trained operators. Cohen's Kappa coefficient may be employed as a metric to evaluate the agreement between the automated classification and manual classification performed by human experts. Cohen's Kappa coefficient may account for agreement that would be expected by chance, providing a measure of classification performance that is more informative than simple accuracy percentages for imbalanced datasets.

The diffraction quality classification system may achieve a Cohen's Kappa coefficient of 0.68 when evaluated against manual labeling for a first sample dataset. The diffraction quality classification system may achieve a Cohen's Kappa coefficient of 0.64 when evaluated against manual labeling for a second sample dataset. The Cohen's Kappa coefficients of 0.68 and 0.64 may indicate substantial agreement between the automated classification and manual classification according to standard interpretation guidelines for Cohen's Kappa values. The classification performance may be consistent across different sample types, indicating that the sample-independent classification approach may generalize to diverse crystalline materials.

The classification approach may prioritize precision over recall for high-quality samples. Precision may be defined as the fraction of samples classified as a given class that are correctly classified, while recall may be defined as the fraction of samples belonging to a given class that are correctly identified. The prioritization of precision over recall may result in a conservative classification strategy where the system may preferentially avoid classifying poor-quality diffraction patterns as high-quality rather than avoiding the exclusion of high-quality patterns from the Good Diffraction class.

The precision-prioritized classification approach may be designed to align with practical microED data collection requirements. False negatives, where a Good Diffraction pattern is misclassified as Bad Diffraction, may be preferable compared to false positives, where a Bad Diffraction pattern is misclassified as Good Diffraction. False positives may result in acquisition of tilt series data from targets that are unlikely to yield successful structure solutions, consuming microscope time and storage resources without producing usable data. False negatives may result in exclusion of some suitable targets from the acquisition list, but the multi-target selection approach may provide sufficient alternative targets to compensate for occasional missed opportunities.

The conservative classification approach may ensure that microscope time is appropriately invested in promising crystals while maintaining sufficient diversity in the selected targets. The precision-prioritized strategy may reduce the fraction of acquired datasets that fail to index or yield successful structure solutions. The classification thresholds may be configured to achieve the desired balance between precision and recall based on the characteristics of the microscope-camera pair and the typical sample types being analyzed.

The methods described herein may be integrated to perform fully autonomous electron diffraction data acquisition from sample insertion through structure determination. The integration of the imaging atlas acquisition, segmentation algorithm, eucentric plane regression, diffraction mapping, on-the-fly processing, diffraction quality classification, target selection, tilt series acquisition, AutoProcess indexing, and AutoSolve phasing components may enable a continuous workflow that proceeds without human intervention. The communication between the microscope control system and the data processing components may be coordinated through a software suite that manages the sequence of operations and passes information between processing stages.

The methods disclosed herein may enable diffraction mapping and collection of about nine high-quality tilt series datasets within 2-3 hours from initialization. The 2-3 hour timeline may encompass the acquisition of the imaging atlas, identification of grid squares through the segmentation algorithm, eucentric height determination at about five reference points, eucentric plane regression and correction for all grid squares, diffraction mapping across the identified grid squares, on-the-fly diffraction quality classification, target selection based on the multi-criteria approach, and acquisition of about nine continuous rotation tilt series at the selected target positions. The rapid data acquisition timeline may be achieved through the elimination of human decision-making steps that would otherwise introduce delays between processing stages.

The installation and optimization of diffraction processing parameters may be completed in less than 2 hours for new microscope configurations. The installation process may involve configuration of the Gaussian filter parameters for peak detection and the Fourier Transform pattern quality analysis thresholds for the specific microscope-camera pair. The less than 2 hour installation time may enable deployment of the autonomous data acquisition system on different microscope platforms without extended calibration or optimization periods. The rapid installation capability may facilitate adoption of the autonomous workflow across multiple microscope facilities.

The methods may comprise autonomously screening crude extracts to identify and determine structures of natural products from complex mixtures without prior knowledge of the compounds present. The sample-independent diffraction classification approach may enable the identification of crystalline material within crude extract samples regardless of the chemical identity of the crystalline phases. The diffraction mapping process may detect regions exhibiting high-quality diffraction within the crude extract sample, and the target selection process may prioritize these regions for tilt series data acquisition. The AutoProcess indexing and AutoSolve phasing components may determine unit cell parameters and solve crystal structures for the identified crystalline phases without requiring prior information regarding the molecular structures present in the crude extract. The autonomous crude extract screening capability may enable discovery of natural products and other compounds from complex biological or chemical mixtures through a fully automated workflow.

### DEFINITIONS

Unless otherwise defined herein, scientific and technical terms used in this application shall have the meanings that are commonly understood by those of ordinary skill in the art.

The methods and techniques of the present disclosure are generally performed, unless otherwise indicated, according to conventional methods well known in the art and as described in various general and more specific references that are cited and discussed throughout this specification.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

All of the above, and any other publications, patents and published patent applications referred to in this application are specifically incorporated by reference herein. In case of conflict, the present specification, including its specific definitions, will control.

As used herein, the term “diffraction mode” refers to an operational configuration of an electron microscope in which the microscope is configured to capture diffraction patterns from a sample rather than real-space images, wherein the electron beam interacts with crystalline material to produce a pattern of diffracted electrons that is recorded by a detector.

As used herein, the term “imaging mode” refers to an operational configuration of an electron microscope in which the microscope is configured to capture real-space images of a sample at a specified magnification, as distinguished from diffraction mode.

As used herein, the term “diffraction snapshot” refers to a single diffraction pattern image acquired at a specific stage coordinate position while the electron microscope operates in diffraction mode, the diffraction snapshot capturing the diffraction information from the sample material at that location.

As used herein, the term “on-the-fly” refers to processing that occurs concurrently with or immediately following data acquisition, such that analysis results are available without requiring completion of an entire data collection session before processing begins.

As used herein, the term “diffraction quality” refers to a classification or metric characterizing the suitability of a diffraction pattern for subsequent structural analysis.

The term “eucentric height” is art-recognized and refers to the z-position of a sample stage at which tilting the stage does not result in lateral displacement of the sample within the field of view, enabling the sample to remain centered during tilt series acquisition.

The term “eucentric plane regression” is art-recognized and refers to a computational method for determining the eucentric height across a sample grid by fitting a plane to eucentric height measurements obtained at multiple reference points distributed across the grid surface.

The term “tilt-series data” is art-recognized and refers to a sequence of diffraction frames acquired while the microscope stage rotates through a defined angular range, enabling sampling of reciprocal space as the crystal rotates through different orientations relative to the electron beam.

The term “serial crystallography” is art-recognized and refers to a sequence of diffraction frames acquired while the microscope stage remains at the same angle and the sampling of reciprocal space is reconstructed using combinations of multiple diffraction snapshots from different crystals of the same crystalline material that were positioned on the grid in different spatial orientations relative to the electron beam.

As used herein, the term “continuous rotation” refers to a data acquisition mode in which the microscope stage rotates continuously through an angular range while diffraction frames are acquired, as distinguished from step-wise acquisition where the stage pauses at discrete angular positions.

The term “Patterson space” is art-recognized and refers to the autocorrelation function of the electron density distribution within a crystal structure, computed from the squared magnitudes of structure factors, which provides information regarding interatomic vector distributions without requiring phase information.

As used herein, the term “spatial awareness” refers to the tracking and consideration of spatial coordinates during target selection to prevent redundant data acquisition from adjacent or overlapping regions of the same crystallite.

As used herein, the term “grid square” refers to an individual opening or window within the mesh structure of an electron microscopy grid, bounded by grid bars, through which electron diffraction data can be collected from sample material deposited on a supporting film.

As used herein, the term “imaging atlas” refers to a low-magnification montage image of an electron microscopy grid that captures the spatial arrangement of grid squares and sample distribution across the grid surface.

As used herein, the term “segmentation algorithm” refers to a computational method for identifying and delineating distinct regions within an image, such as identifying grid square boundaries within an imaging atlas based on contrast differences between grid bars and grid square openings.

As used herein, the term “ab initio structure determination” refers to solving a crystal structure from diffraction data without requiring prior knowledge of the molecular structure or isomorphous replacement experiments, typically employing direct methods that exploit statistical relationships among structure factor phases.

The term “direct methods” is art-recognized and refers to computational approaches for determining crystallographic phases from diffraction intensity data by exploiting mathematical relationships among structure factors, as implemented in software packages such as SHELXT and SHELXD.

As used herein, the term “real-space coordinates” refers to spatial positions expressed in physical length units such as micrometers, as distinguished from pixel-based coordinates that depend on image resolution and magnification settings.

As used herein, the term “diffraction quality atlas” refers to a spatial map correlating stage coordinates with diffraction quality classifications, enabling visualization of diffraction quality distribution across a sample grid.

As used herein, the term “crystal target” refers to a specific stage coordinate position identified as containing crystalline material exhibiting diffraction characteristics suitable for tilt-series data acquisition.

As used herein, the term “minimum spacing” refers to a distance constraint enforced between selected crystal targets to ensure that data is collected from distinct crystallites rather than from adjacent or overlapping regions of the same crystal.

As used herein, the term “classification algorithm” refers to an algorithm configured to characterize the suitability of a diffraction pattern or a diffraction snapshot for subsequent structural analysis, based on factors including, but not limited to, the number of diffraction peaks, diffraction intensity, and lattice periodicity as assessed through Fourier Transform analysis. For example, the classification algorithm may be a machine learning model or a deep learning model, such as a convolutional neural network, trained on a dataset comprising a plurality of labeled diffraction patterns and/or diffraction snapshots. Statistical methods of pattern classification may be suitable to differentiate the quality of the observed diffraction.

Statistical methods of pattern classification may include, but are not limited to, an azimuthal uniformity test, a Wilson plot linearity, a 2D autocorrelation, a spot shape analysis, a lattice residual scoring, or a Ripley's K-function.

As used herein, the term “grid”, when used in reference to the diffraction quality classification, refers to the category comprising diffraction snapshots acquired at positions corresponding to grid bar structures rather than grid square openings. The grid category may be identified based on characteristic intensity patterns associated with electron scattering from the metallic grid bar material.

As used herein, the term “no diffraction”, when used in reference to the diffraction quality classification, refers to the category comprising diffraction snapshots that lack detectable diffraction peaks above the background noise level. The no diffraction category may correspond to positions on the grid where no crystalline material is present or where the sample material is amorphous.

As used herein, the term “poor diffraction”, when used in reference to the diffraction quality classification, refers to the category comprising diffraction snapshots having fewer than about 10 diffraction peaks. The poor diffraction category may be identified through the minimum diffraction peak threshold without requiring additional Fourier Transform analysis.

As used herein, the term “bad diffraction”, when used in reference to the diffraction quality classification, refers to the category comprising diffraction snapshots having greater than about 10 diffraction peaks but exhibiting characteristics inconsistent with high-quality single crystal diffraction. In some cases, the bad diffraction category may correspond to polycrystalline diffraction patterns where multiple crystal orientations contribute to the observed diffraction. The bad diffraction category may be distinguished from the good diffraction category based on the number and arrangement of peaks in the diffraction snapshots or in the Fourier Transform image of the diffraction snapshots and/or processed outputs of these diffraction snapshots. A bad diffraction category snapshot may have a ratio of the number of peaks in the Fourier Transform image to the number of peaks in the diffraction snapshot most preferably from about 1-3.

As used herein, the term “good diffraction”, when used in reference to the diffraction quality classification, refers to the category comprising diffraction snapshots exhibiting characteristics consistent with high-quality single crystal diffraction. The good diffraction category may be characterized by greater than about 10 diffraction peaks and a high number of peaks in the Fourier Transform image. A good diffraction category snapshot may have a ratio of the number of peaks in the Fourier Transform image to the number of peaks in the diffraction snapshot from about 3-20, most preferably from about 3-10. The good diffraction category may indicate that the corresponding stage position contains a crystal suitable for tilt series data acquisition. Positions categorized as “good diffraction” may be prioritized for subsequent continuous rotation data collection. For example, the “good diffraction” category may comprise the crystal targets having the highest ranking in the ranked list (e.g., the three to five crystal targets having the highest ranking in the ranked list).

### EXAMPLES

The invention now being generally described, it will be more readily understood by reference to the following examples which are included merely for purposes of illustration of certain aspects and embodiments of the present invention and are not intended to limit the invention.

The methods of the present disclosure are additionally described in Eremin, D. B. et al. J. Am. Chem. Soc. 2025, 147(46): 42299-42310, the contents of which are incorporated herein by reference in their entirety.

### Example 1: Sample Preparation

Samples were prepared using 200 mesh Cu grids. Lacey Carbon film or Formvar/Carbon film coatings were applied to the grids. For preparation of (S,S)-salen ligand, grossular, biotin, and Cu(D-Ser)₂ samples, grids were placed in a dram vial with approximately 1 mg of compound and shaken lightly. For preparation of AVAAGA peptide sample, 2 L of crystal slurry was deposited onto grids and residual water was carefully removed with filter paper after 2 minutes. Citrinovirin was isolated from an A. nidulans transformant expressing treABCDE. Carbamazepine sample was prepared using a 10 mM solution in 40% ACN in H₂O, and the solution was arrayed onto the grid using ArrayED technology. All samples were transferred to the sample holder or autoloader under ambient conditions with no additional experimental setup.

### Example 2: Automated Data Collection

Data were automatically collected using REyes suite which comprises of scripted SerialEM acquisition on a corresponding transmission electron microscope (TEM) guided by REyes python package.

### Talos F200C

Data were acquired on a Talos F200C side-entry TEM (Thermo Fisher Scientific) operating at 200 keV (electron wavelength 0.0251 Å) and equipped with a Direct Electron Apollo camera (8192×8192 pixels maximum resolution). The microscope was configured to a spot size 11 and a 50 μm C2 aperture. Prior to data collection, the microscope alignment was verified to produce a near-parallel, 3.5 m-wide beam at −44.5% C2 lens current (spot size 11). The beam was focused at the back focal plane of the objective lens, assumed to be coplanar with the objective aperture (70 m).

A grid montage was acquired, and the eucentric height was determined using the imaging mode (LM 155×). For diffraction, the camera length was set to 420 mm, corresponding to a calibrated 540 mm on the Apollo detector, yielding −0.8 Å resolution at the frame edge. A standard tilt series was collected spanning +500 to −50° at a rate of 1° s⁻¹, covering a total tilt range of 100°.

Room temperature sample holder was used. All images were recorded using a 4x binning. For montage, eucentricity routines, and diffraction mapping, an exposure time of 0.25 s was used. Tilt movies were acquired at a 1 s exposure time.

### Talos Arctica

Data were acquired on a Talos Arctica TEM (Thermo Fisher Scientific) operating at 200 keV (electron wavelength 0.0251 Å) and equipped with an Autoloader operating at 80 K and a CETA-D camera (4096×4096 pixels maximum resolution). The microscope was configured to a spot size 10 and a 50 μm C2 aperture. Prior to data collection, the microscope alignment was verified to produce a near-parallel, 12.5 m-wide beam at −45.3% C2 lens current (spot size 10). The beam was focused at the back focal plane of the objective lens, assumed to be coplanar with the objective aperture (70 m).

A grid montage was acquired, and the eucentric height was determined using the imaging mode (LM 210×). For diffraction, the camera length was set to a calibrated 960 mm distance on the CETA-D detector, yielding −0.8 Å resolution at the frame edge. A standard tilt series was collected spanning +50° to −50° at a rate of 0.3° s⁻¹, covering a total tilt range of 100°.

Microscope stage was kept at 80 K. All images with CETA-D detector were recorded using a 2× binning. For montage, eucentricity routines an exposure time of 3 s was used, and for diffraction mapping exposure time was 1 s. Tilt movies were acquired at a 1 s exposure time.

Alternatively, a grid montage was acquired, and the eucentric height was determined using the imaging mode (LM 115×). For diffraction, the camera length was set to a calibrated 560 mm distance on the DE Apollo detector, yielding −0.8 Å resolution at the frame edge. A standard tilt series was collected spanning +500 to −50° at a rate of 1° s⁻¹, covering a total tilt range of 100°.

Microscope stage was kept at 80 K. All images with DE Apollo detector were recorded using a 4× binning. For montage, eucentricity routines an exposure time of 1 s was used, and for diffraction mapping exposure time was 0.25 s. Tilt movies were acquired at a 1 s exposure time.

### TF30

Data were acquired on a TF-30 side-entry TEM (FEI Tecnai) operating at 300 keV (electron wavelength 0.0197 Å) and equipped with a TVIPS TemCam-XF416 CMOS camera (4096×4096 pixels maximum resolution). The microscope was configured to a spot size 11 and a 50 μm C2 aperture. Prior to data collection, the microscope alignment was verified to produce a near-parallel, beam at −42.5% C2 lens current (spot size 11). The beam was focused at the back focal plane of the objective lens, assumed to be coplanar with the objective aperture (70 m).

A grid montage was acquired, and the eucentric height was determined using the imaging mode (LM 280×). For diffraction, the camera length was set to 750 mm, corresponding to a calibrated 1320 mm on the TVIPS detector, yielding ~0.8 Å resolution at the frame edge. A standard tilt series was collected spanning +50° to −50° at a rate of 0.5° s⁻¹, covering a total tilt range of 100°.

Room temperature sample holder was used. All images were recorded using a 2× binning. For montage, eucentricity routines an exposure time of 1 s was used, and for diffraction mapping exposure time was 0.5 s. Tilt movies were acquired at a 1 s exposure time.

### Spectra 300C

Data were acquired on a Spectra 300C side-entry TEM (Thermo Fisher Scientific) operating at 300 keV (electron wavelength 0.0197 Å) and equipped with a CETA-D camera (4096×4096 pixels maximum resolution). The microscope was configured to a spot size 10 and a 50 μm C2 aperture. Focused 4 μm parallel beam was used.

A grid montage was acquired, and the eucentric height was determined using the imaging mode (LM 205×). For diffraction, the camera length was set to 680 mm, corresponding to a calibrated 1224 mm on the CETA-D detector, yielding −0.8 Å resolution at the frame edge. A standard tilt series was collected spanning +50° to −50° at a rate of 0.3° s⁻¹, covering a total tilt range of 100°.

Room temperature sample holder was used. All images were recorded using a 2× binning. For montage, eucentricity routines an exposure time of 0.5 s was used, and for diffraction mapping exposure time was 1 s. Tilt movies were acquired at a 1 s exposure time.

### Example 3: Autonomous Processing of MicroED Data

MicroED movies were on-the-fly automatically processed with developed software processing suite AutoProcess 2.0. Data first is converted with enclosed mrc2tif file converter with pedestal value of 1 uniformly added to every frame. Next TIF images are processed using XDS package.

### Example 4: Autonomous Structure Determination and Subsequent Refinement

After all continuous rotation microED data have been collected and processed our developed AutoSolve package was initiated. Structures were auto-solved ab initio by direct methods in SHELXT and SHELXD and the direct preliminary solution is included for each entry. Best solution an autonomous session has been then selected for further refinement. If needed data has been manually fine-tuned to improve structure quality.

Structures were refined with SHELXL and olex.refine using Olex2 and incorporating electron scattering factors. Thermal parameters were refined anisotropically for all non-hydrogen atoms. Hydrogen atoms were assigned using the riding model unless otherwise noted.

### Example 5: LC-HRMS Data Collection

Mass spectra were measured using an Agilent 6230B time-of-flight (ToF) instrument coupled with 1200 LC system. The ToF mass spectrometer was equipped with a dual AJS ionization source. In positive ion mode ionization parameters are as follows: Capillary Voltage −3.5 kV, Nozzle Voltage −1.0 kV, nitrogen was applied as a nebulizer gas 35 psi, dry gas 8 L×min⁻¹, 320 °C, and sheath gas 11 L×min⁻¹, 325 °C. Mass spectra were recorded in m/z 100-1300 range. The following solvent gradient was used in the LC-HRMS measurements: A 0.05% acetic acid in H₂O, B—MeCN; 0% to 15% B in 15 min, ramp to 50% B by 28 min, ramp to 100% B by 30 min and hold for 4 min, return to 0% by 30.1 min and hold for 4.9 min. All the MS spectra were recorded at 1 Hz. The spectra were processed using the Agilent MassHunter 10.0 software package.

### Example 6: Structure Determination of (S,S)-Salen Ligand

A sample of (S,S)-salen ligand was analyzed using the autonomous data acquisition system on a Talos F200C microscope equipped with a DE Apollo camera. The system initiated acquisition in a narrow mode to conduct diffraction mapping within ±200 μm from the stage origin. Through the grid square search, 10 potential locations were identified and mapped within 2.3 hours from the moment of system initiation.

The target list was curated to include the top three targets from the good diffraction quality list, the highest number of diffraction peaks list, and the greatest frame-sum intensity list. Each target was selected with identity and spatial awareness, ensuring no redundancy and maintaining a minimum distance of 10.1 μm between any two targets. All nine datasets were acquired with the Apollo direct electron camera in less than 0.5 hours.

The acquired datasets underwent on-the-fly autonomous processing using the XDS backend. Out of nine continuous rotation movies within a ±500 range, seven were successfully indexed to the anticipated unit cell and space group, one indexed to the expected dimensions in a lower symmetry group, and one movie failed to index autonomously. Target 213, identified in grid square #8, with the highest completeness at 77.5%, yielded an ab initio phasing solution at 0.8 Å from a single movie. The preliminary solution generated by SHELXD correctly elucidated the molecular structure and was successfully refined kinematically.

The same grid was subsequently analyzed using the Talos Arctica microscope with a CETA-D detector, revealing a different target set due to altered grid orientation on the stage. A new target also resulted in a single-movie solution.

TABLE 1
AutoProcess indexing of acquired microED data for (S,S)-salen ligand (1)

| | | | Unit cell | | | |
|---|---|---|---|---|---|---|
| | | XDS space | parameters | | | Completeness at |
| Entry | Target | group | (a, b, c, α, β, γ) | I/σ | CC ½ | 0.8 Å |
| 1 | 101 | P222 (#16) | 6.62 17.92 26.86 | 7.75 | 98.5% | 62.3% |
| | | | 90 90 90 | | | |
| 2 | 104 | P222 (#16) | 6.60 17.95 27.12 | 6.84 | 96.9% | 69.9% |
| | | | 90 90 90 | | | |
| 3 | 108 | P1 (#1) | 2.07 5.17 14.95 | 1.73 | 82.1% | 36.1% |
| | | | 85.56 87.87 83.55 | | | |
| 4 | 205 | P222 (#16) | 6.59 17.95 27.15 | 3.44 | 89.9% | 67.8% |
| | | | 90 90 90 | | | |
| 5 | 210 | P222 (#16) | 6.63 17.85 27.19 | 4.73 | 97.7% | 68.5% |
| | | | 90 90 90 | | | |
| 6 | 213 | P222 (#16) | 6.62 17.82 27.28 | 10.1 | 98.9% | 82.1% |
| | | | 90 90 90 | | | |
| 7 | 307 | P222 (#16) | 6.62 17.80 29.23 | 1.47 | 17.4% | 68.2% |
| | | | 90 90 90 | | | |
| 8 | 308 | P1 (#1) | 6.62 17.83 31.00 | 9.98 | 76.5% | 27.8% |
| | | | 92.10 93.15 90.51 | | | |
| 9 | 310 | P222 (#16) | 6.67 17.88 27.00 | 1.82 | 68.9% | 91.9% |
| | | | 90 90 90 | | | |

### Example 7: Structure Determination of Grossular

A sample of grossular mineral was analyzed using the autonomous data acquisition system on a Talos F200C microscope equipped with a DE Apollo camera. Grossular, with its densely populated grid lacking uniformly crystalline particles, typically requires numerous hours for manual screening. The autonomous system screened the grid and collected nine movie datasets within three hours. The molecular structure was solved ab initio from a single movie through the fully autonomous workflow without human intervention.

### Example 8: Structure Determination of Biotin

A sample of biotin (vitamin 1B7) was analyzed using the autonomous data acquisition system on a Talos F200C microscope equipped with a DE Apollo camera. Biotin exhibits moderate beam sensitivity. The autonomous pipeline yielded a dataset with high completeness at 98.6% following ab initio phasing. The molecular structure was solved ab initio from a single movie through the fully autonomous workflow without human intervention.

### Example 9: Structure Determination of AVAAGA Peptide

A sample of AVAAGA peptide was analyzed using the autonomous data acquisition system on a Talos F200C microscope equipped with a DE Apollo camera at room temperature. The AVAAGA peptide is known for challenging acquisition at room temperature, often posing difficulties even for experienced users without merging. The autonomous system delivered a single-movie solution in under three hours that was successfully phased. The same sample was subsequently analyzed at cryogenic temperatures with the Arctica microscope and CETA-D detector, achieving the expected structural outcome.

### Example 10: Structure Determination of Cu(D-Ser)₂

A sample of Cu(D-Ser)₂ complex was analyzed using the autonomous data acquisition system on a Talos F200C microscope equipped with a DE Apollo camera at room temperature. The Cu(D-Ser)₂ complex is known for challenging acquisition at room temperature due to high beam sensitivity. The autonomous system delivered a single-movie solution in under three hours that was successfully phased. The same sample was subsequently analyzed at cryogenic temperatures with the Arctica microscope and CETA-D detector, achieving the expected structural outcome.

### Example 11: Structure Determination of Citrinovirin from Crude Extract

A sample of citrinovirin was analyzed using the autonomous data acquisition system. Citrinovirin was isolated from an A. nidulans transformant expressing treABCDE. The autonomous system identified crystalline material within the sample and selected targets exhibiting high-quality diffraction for tilt series data acquisition. The structure was determined through the autonomous workflow.

### Example 12: Structure Determination of Carbamazepine

A sample of carbamazepine was analyzed using the autonomous data acquisition system on an Arctica microscope equipped with a CETA-D camera. The carbamazepine sample was prepared using a 10 mM solution in 40% ACN in H₂O and arrayed onto the grid using ArrayED technology. The autonomous system performed diffraction mapping across the grid, identified targets exhibiting high-quality diffraction, and acquired tilt series data at the selected target positions. The structure was determined through the autonomous workflow.

### Example 13: Diffraction Quality Classification Validation

The diffraction quality classification system was evaluated using two datasets acquired using the Talos microscope: (S,S)-salen ligand and biotin. Classification followed precise numerical thresholds (Gaussian filters for peak detection and Fourier Transform pattern quality analysis) tailored to each microscope-camera pair. The thresholds were determined upon system installation in less than 2 hours total time. The central 25% of each image was masked during peak detection, ensuring that Good classifications reflected high-resolution features of the diffraction pattern rather than low-resolution features.

The system achieved Cohen's Kappa coefficients of 0.68 and 0.64 across the two datasets, indicating substantial agreement between automated and manual classification. The conservative classification approach prioritized precision over recall for high-quality samples. The normalized confusion matrices revealed that misclassifications primarily occurred between adjacent quality categories, with only 8% of images (18 out of 223) manually labeled as Bad being classified as Good, which represented an acceptable compromise for subsequent data collection.

### Example 14: Data Quality Comparison

Data quality was compared between autonomous acquisition and manual data collection for multiple compounds including grossular, biotin, AVAAGA peptide, and Cu(D-Ser)₂. Fractal dimension measurements were performed for autonomous versus manual data collection. R_{merge} values were plotted against 2θ resolution for both acquisition approaches. The data quality metrics demonstrated that the autonomous acquisition system produced diffraction data of comparable quality to manually collected data while eliminating human intervention from the data acquisition process.

### Example 15: Exemplary Diffraction Quality Index Calculations

Exemplary diffraction quality index calculations for every frame of the complete continuous rotation datasets for the best (entry 6) and worst (entry 8) entries shown in Table 1 are provided in Table 2 and Table 3 below.

TABLE 2
Exemplary DQI calculations for best S,S-
salen ligand continuous rotation dataset

| | | No. | | | |
|---|---|---|---|---|---|
| | No. of | of | | | |
| Frame | Diffraction | Pattern | DQI | Total | Avg. |
| No. | Spots | Spots | Category | Sum | DQI |
| 1 | 32 | 3167 | Good | 6346767 | 98.96875 |
| | | | diffraction | | |
| 2 | 31 | 2283 | Good | 6308797 | 73.64516 |
| | | | diffraction | | |
| 3 | 29 | 2739 | Good | 6254211 | 94.44828 |
| | | | diffraction | | |
| 4 | 33 | 2765 | Good | 6211390 | 83.78788 |
| | | | diffraction | | |
| 5 | 30 | 2651 | Good | 6142548 | 88.36667 |
| | | | diffraction | | |
| 6 | 24 | 1643 | Good | 6143017 | 68.45833 |
| | | | diffraction | | |
| 7 | 33 | 2027 | Good | 6016236 | 61.42424 |
| | | | diffraction | | |
| 8 | 30 | 3593 | Good | 5952364 | 119.7667 |
| | | | diffraction | | |
| 9 | 32 | 3059 | Good | 5946335 | 95.59375 |
| | | | diffraction | | |
| 10 | 25 | 1473 | Good | 5872040 | 58.92 |
| | | | diffraction | | |
| 11 | 38 | 2383 | Good | 5731047 | 62.71053 |
| | | | diffraction | | |
| 12 | 31 | 2283 | Good | 5775689 | 73.64516 |
| | | | diffraction | | |
| 13 | 31 | 2237 | Good | 5713043 | 72.16129 |
| | | | diffraction | | |
| 14 | 27 | 3033 | Good | 5735980 | 112.3333 |
| | | | diffraction | | |
| 15 | 35 | 2465 | Good | 5576833 | 70.42857 |
| | | | diffraction | | |
| 16 | 31 | 2357 | Good | 5616034 | 76.03226 |
| | | | diffraction | | |
| 17 | 30 | 1973 | Good | 5549078 | 65.76667 |
| | | | diffraction | | |
| 18 | 24 | 2213 | Good | 5409994 | 92.20833 |
| | | | diffraction | | |
| 19 | 41 | 2893 | Good | 5401988 | 70.56098 |
| | | | diffraction | | |
| 20 | 33 | 1997 | Good | 5447491 | 60.51515 |
| | | | diffraction | | |
| 21 | 39 | 2317 | Good | 5515566 | 59.41026 |
| | | | diffraction | | |
| 22 | 24 | 2259 | Good | 5339652 | 94.125 |
| | | | diffraction | | |
| 23 | 32 | 2607 | Good | 5290224 | 81.46875 |
| | | | diffraction | | |
| 24 | 36 | 2659 | Good | 5197581 | 73.86111 |
| | | | diffraction | | |
| 25 | 31 | 1775 | Good | 5204945 | 57.25806 |
| | | | diffraction | | |
| 26 | 29 | 2853 | Good | 5198624 | 98.37931 |
| | | | diffraction | | |
| 27 | 25 | 2211 | Good | 5183839 | 88.44 |
| | | | diffraction | | |
| 28 | 32 | 1821 | Good | 5024657 | 56.90625 |
| | | | diffraction | | |
| 29 | 35 | 1487 | Good | 4974145 | 42.48571 |
| | | | diffraction | | |
| 30 | 27 | 1477 | Good | 5107035 | 54.7037 |
| | | | diffraction | | |
| 31 | 26 | 1499 | Good | 5091538 | 57.65385 |
| | | | diffraction | | |
| 32 | 36 | 2533 | Good | 4959194 | 70.36111 |
| | | | diffraction | | |
| 33 | 29 | 1507 | Good | 5073526 | 51.96552 |
| | | | diffraction | | |
| 34 | 25 | 1535 | Good | 4930532 | 61.4 |
| | | | diffraction | | |
| 35 | 26 | 2025 | Good | 4923859 | 77.88462 |
| | | | diffraction | | |
| 36 | 26 | 1493 | Good | 4965646 | 57.42308 |
| | | | diffraction | | |
| 37 | 27 | 1641 | Good | 4918899 | 60.77778 |
| | | | diffraction | | |
| 38 | 28 | 2243 | Good | 4800540 | 80.10714 |
| | | | diffraction | | |
| 39 | 29 | 2681 | Good | 4735266 | 92.44828 |
| | | | diffraction | | |
| 40 | 28 | 2275 | Good | 4767861 | 81.25 |
| | | | diffraction | | |
| 41 | 30 | 1743 | Good | 4826446 | 58.1 |
| | | | diffraction | | |
| 42 | 26 | 1689 | Good | 4938854 | 64.96154 |
| | | | diffraction | | |
| 43 | 26 | 2485 | Good | 4652881 | 95.57692 |
| | | | diffraction | | |
| 44 | 23 | 2081 | Good | 4602924 | 90.47826 |
| | | | diffraction | | |
| 45 | 24 | 1901 | Good | 4573247 | 79.20833 |
| | | | diffraction | | |
| 46 | 25 | 2407 | Good | 4565645 | 96.28 |
| | | | diffraction | | |
| 47 | 35 | 2721 | Good | 4551092 | 77.74286 |
| | | | diffraction | | |
| 48 | 29 | 1947 | Good | 4553696 | 67.13793 |
| | | | diffraction | | |
| 49 | 24 | 1517 | Good | 4637659 | 63.20833 |
| | | | diffraction | | |
| 50 | 21 | 1093 | Good | 4645815 | 52.04762 |
| | | | diffraction | | |
| 51 | 28 | 2445 | Good | 4558649 | 87.32143 |
| | | | diffraction | | |
| 52 | 38 | 2653 | Good | 4491095 | 69.81579 |
| | | | diffraction | | |
| 53 | 35 | 2553 | Good | 4489647 | 72.94286 |
| | | | diffraction | | |
| 54 | 23 | 1857 | Good | 4516802 | 80.73913 |
| | | | diffraction | | |
| 55 | 28 | 1549 | Good | 4632188 | 55.32143 |
| | | | diffraction | | |
| 56 | 43 | 1647 | Good | 4651803 | 38.30233 |
| | | | diffraction | | |
| 57 | 17 | 748 | Good | 4504083 | 44 |
| | | | diffraction | | |
| 58 | 23 | 1651 | Good | 4381315 | 71.78261 |
| | | | diffraction | | |
| 59 | 22 | 1315 | Good | 4384174 | 59.77273 |
| | | | diffraction | | |
| 60 | 27 | 2419 | Good | 4409138 | 89.59259 |
| | | | diffraction | | |
| 61 | 20 | 1417 | Good | 4353206 | 70.85 |
| | | | diffraction | | |
| 62 | 20 | 1327 | Good | 4436223 | 66.35 |
| | | | diffraction | | |
| 63 | 14 | 1059 | Good | 4468318 | 75.64286 |
| | | | diffraction | | |
| 64 | 18 | 1397 | Good | 4409116 | 77.61111 |
| | | | diffraction | | |
| 65 | 18 | 1723 | Good | 4396286 | 95.72222 |
| | | | diffraction | | |
| 66 | 24 | 1631 | Good | 4398903 | 67.95833 |
| | | | diffraction | | |
| 67 | 20 | 1155 | Good | 4328177 | 57.75 |
| | | | diffraction | | |
| 68 | 18 | 1447 | Good | 4325028 | 80.38889 |
| | | | diffraction | | |
| 69 | 26 | 1971 | Good | 4313019 | 75.80769 |
| | | | diffraction | | |
| 70 | 18 | 871 | Good | 4348497 | 48.38889 |
| | | | diffraction | | |
| 71 | 20 | 1321 | Good | 4324487 | 66.05 |
| | | | diffraction | | |
| 72 | 19 | 1815 | Good | 4357845 | 95.52632 |
| | | | diffraction | | |
| 73 | 19 | 729 | Good | 4309071 | 38.36842 |
| | | | diffraction | | |
| 74 | 16 | 1885 | Good | 4324818 | 117.8125 |
| | | | diffraction | | |
| 75 | 17 | 251 | Good | 4287289 | 14.76471 |
| | | | diffraction | | |
| 76 | 13 | 129 | Good | 4291398 | 9.923077 |
| | | | diffraction | | |
| 77 | 11 | 100 | Good | 4333219 | 9.090909 |
| | | | diffraction | | |
| 78 | 10 | 1645 | Good | 4483638 | 164.5 |
| | | | diffraction | | |
| 79 | 12 | 138 | Good | 4372186 | 11.5 |
| | | | diffraction | | |
| 80 | 16 | 572 | Good | 4367889 | 35.75 |
| | | | diffraction | | |
| 81 | 21 | 1439 | Good | 4338417 | 68.52381 |
| | | | diffraction | | |
| 82 | 21 | 649 | Good | 4337048 | 30.90476 |
| | | | diffraction | | |
| 83 | 13 | 1019 | Good | 4400134 | 78.38462 |
| | | | diffraction | | |
| 84 | 14 | 37 | Good | 4358108 | 2.642857 |
| | | | diffraction | | |
| 85 | 11 | 263 | Good | 4385142 | 23.90909 |
| | | | diffraction | | |
| 86 | 14 | 5 | Bad | 4328248 | 0.357143 |
| | | | diffraction | | |
| 87 | 5 | 0 | Poor | 4412786 | 0 |
| | | | diffraction | | |
| 88 | 17 | 15 | Bad | 4373744 | 0.882353 |
| | | | diffraction | | |
| 89 | 17 | 3 | Bad | 4378701 | 0.176471 |
| | | | diffraction | | |
| 90 | 8 | 1395 | Poor | 4483845 | 174.375 |
| | | | diffraction | | |
| 91 | 12 | 1033 | Good | 4439079 | 86.08333 |
| | | | diffraction | | |
| 92 | 15 | 7 | Bad | 4427887 | 0.466667 |
| | | | diffraction | | |
| 93 | 10 | 3 | Bad | 4479684 | 0.3 |
| | | | diffraction | | |
| 94 | 8 | 9 | Poor | 4535761 | 1.125 |
| | | | diffraction | | |
| 95 | 13 | 19 | Good | 4537143 | 1.461538 |
| | | | diffraction | | |
| 96 | 9 | 10 | Poor | 4617017 | 1.111111 |
| | | | diffraction | | |
| 97 | 7 | 1 | Poor | 4629056 | 0.142857 |
| | | | diffraction | | |
| 98 | 5 | 1 | Poor | 4646430 | 0.2 |
| | | | diffraction | | |
| 99 | 6 | 1 | Poor | 4707039 | 0.166667 |
| | | | diffraction | | |
| 100 | 7 | 1 | Poor | 4785795 | 0.142857 |
| | | | diffraction | | |
| | | | | | 61.63496 |

TABLE 3
Exemplary DQI calculations for worst S,S-
salen ligand continuous rotation dataset

| | | No. | | | |
|---|---|---|---|---|---|
| | No. of | of | | | |
| Frame | Diffraction | Pattern | DQI | Total | Avg. |
| No. | Spots | Spots | Category | Sum | DQI |
| 1 | 1 | 0 | No | 5190707 | 0 |
| | | | diffraction | | |
| 2 | 0 | 0 | No | 5272885 | 0 |
| | | | diffraction | | |
| 3 | 0 | 0 | No | 5380285 | 0 |
| | | | diffraction | | |
| 4 | 1 | 0 | No | 5496347 | 0 |
| | | | diffraction | | |
| 5 | 0 | 0 | No | 5593504 | 0 |
| | | | diffraction | | |
| 6 | 6 | 0 | Poor | 5709646 | 0 |
| | | | diffraction | | |
| 7 | 0 | 0 | No | 5769215 | 0 |
| | | | diffraction | | |
| 8 | 1 | 0 | No | 5865112 | 0 |
| | | | diffraction | | |
| 9 | 6 | 0 | Poor | 5959994 | 0 |
| | | | diffraction | | |
| 10 | 5 | 2 | Poor | 6018215 | 0.4 |
| | | | diffraction | | |
| 11 | 3 | 0 | Poor | 6063046 | 0 |
| | | | diffraction | | |
| 12 | 6 | 0 | Poor | 6117455 | 0 |
| | | | diffraction | | |
| 13 | 7 | 0 | Poor | 6174024 | 0 |
| | | | diffraction | | |
| 14 | 10 | 149 | Good | 6230019 | 14.9 |
| | | | diffraction | | |
| 15 | 8 | 6 | Poor | 6324935 | 0.75 |
| | | | diffraction | | |
| 16 | 13 | 435 | Good | 6348496 | 33.46154 |
| | | | diffraction | | |
| 17 | 9 | 303 | Poor | 6380820 | 33.66667 |
| | | | diffraction | | |
| 18 | 18 | 1295 | Good | 6429414 | 71.94444 |
| | | | diffraction | | |
| 19 | 11 | 144 | Good | 6478188 | 13.09091 |
| | | | diffraction | | |
| 20 | 14 | 768 | Good | 6525204 | 54.85714 |
| | | | diffraction | | |
| 21 | 9 | 85 | Poor | 6539294 | 9.444444 |
| | | | diffraction | | |
| 22 | 11 | 37 | Good | 6559043 | 3.363636 |
| | | | diffraction | | |
| 23 | 10 | 39 | Good | 6597136 | 3.9 |
| | | | diffraction | | |
| 24 | 11 | 41 | Good | 6611544 | 3.727273 |
| | | | diffraction | | |
| 25 | 15 | 827 | Good | 6600210 | 55.13333 |
| | | | diffraction | | |
| 26 | 10 | 23 | Good | 6602974 | 2.3 |
| | | | diffraction | | |
| 27 | 12 | 132 | Good | 6615120 | 11 |
| | | | diffraction | | |
| 28 | 11 | 431 | Good | 6607386 | 39.18182 |
| | | | diffraction | | |
| 29 | 10 | 1673 | Good | 6643206 | 167.3 |
| | | | diffraction | | |
| 30 | 7 | 202 | Poor | 6639682 | 28.85714 |
| | | | diffraction | | |
| 31 | 12 | 65 | Good | 6584582 | 5.416667 |
| | | | diffraction | | |
| 32 | 14 | 95 | Good | 6606119 | 6.785714 |
| | | | diffraction | | |
| 33 | 11 | 0 | Bad | 6566908 | 0 |
| | | | diffraction | | |
| 34 | 11 | 1473 | Good | 6621943 | 133.9091 |
| | | | diffraction | | |
| 35 | 9 | 376 | Poor | 6618430 | 41.77778 |
| | | | diffraction | | |
| 36 | 9 | 0 | Poor | 6541629 | 0 |
| | | | diffraction | | |
| 37 | 8 | 383 | Poor | 6512337 | 47.875 |
| | | | diffraction | | |
| 38 | 14 | 949 | Good | 6484644 | 67.78571 |
| | | | diffraction | | |
| 39 | 14 | 349 | Good | 6444588 | 24.92857 |
| | | | diffraction | | |
| 40 | 10 | 91 | Good | 6411099 | 9.1 |
| | | | diffraction | | |
| 41 | 13 | 190 | Good | 6383756 | 14.61538 |
| | | | diffraction | | |
| 42 | 19 | 905 | Good | 6342847 | 47.63158 |
| | | | diffraction | | |
| 43 | 13 | 231 | Good | 6319937 | 17.76923 |
| | | | diffraction | | |
| 44 | 20 | 1347 | Good | 6302828 | 67.35 |
| | | | diffraction | | |
| 45 | 12 | 76 | Good | 6288514 | 6.333333 |
| | | | diffraction | | |
| 46 | 15 | 181 | Good | 6236202 | 12.06667 |
| | | | diffraction | | |
| 47 | 12 | 33 | Good | 6202366 | 2.75 |
| | | | diffraction | | |
| 48 | 8 | 0 | Poor | 6174052 | 0 |
| | | | diffraction | | |
| 49 | 8 | 1 | Poor | 6129620 | 0.125 |
| | | | diffraction | | |
| 50 | 7 | 74 | Poor | 6182492 | 10.57143 |
| | | | diffraction | | |
| 51 | 26 | 1203 | Good | 6227805 | 46.26923 |
| | | | diffraction | | |
| 52 | 15 | 574 | Good | 6089490 | 38.26667 |
| | | | diffraction | | |
| 53 | 8 | 20 | Poor | 5991090 | 2.5 |
| | | | diffraction | | |
| 54 | 6 | 0 | Poor | 5957821 | 0 |
| | | | diffraction | | |
| 55 | 17 | 33 | Good | 5903929 | 1.941176 |
| | | | diffraction | | |
| 56 | 19 | 465 | Good | 5870577 | 24.47368 |
| | | | diffraction | | |
| 57 | 11 | 2 | Bad | 5798898 | 0.181818 |
| | | | diffraction | | |
| 58 | 13 | 84 | Good | 5757755 | 6.461538 |
| | | | diffraction | | |
| 59 | 14 | 51 | Good | 5690695 | 3.642857 |
| | | | diffraction | | |
| 60 | 15 | 156 | Good | 5653838 | 10.4 |
| | | | diffraction | | |
| 61 | 9 | 4 | Poor | 5647768 | 0.444444 |
| | | | diffraction | | |
| 62 | 6 | 0 | Poor | 5625419 | 0 |
| | | | diffraction | | |
| 63 | 9 | 0 | Poor | 5562486 | 0 |
| | | | diffraction | | |
| 64 | 12 | 117 | Good | 5500588 | 9.75 |
| | | | diffraction | | |
| 65 | 13 | 1919 | Good | 5508186 | 147.6154 |
| | | | diffraction | | |
| 66 | 10 | 0 | Bad | 5418479 | 0 |
| | | | diffraction | | |
| 67 | 16 | 131 | Good | 5376796 | 8.1875 |
| | | | diffraction | | |
| 68 | 13 | 3 | Bad | 5311104 | 0.230769 |
| | | | diffraction | | |
| 69 | 12 | 148 | Good | 5297227 | 12.33333 |
| | | | diffraction | | |
| 70 | 8 | 0 | Poor | 5258040 | 0 |
| | | | diffraction | | |
| 71 | 12 | 11 | Bad | 5187379 | 0.916667 |
| | | | diffraction | | |
| 72 | 17 | 209 | Good | 5142334 | 12.29412 |
| | | | diffraction | | |
| 73 | 10 | 3 | Bad | 5092101 | 0.3 |
| | | | diffraction | | |
| 74 | 13 | 191 | Good | 5054913 | 14.69231 |
| | | | diffraction | | |
| 75 | 9 | 145 | Poor | 5030658 | 16.11111 |
| | | | diffraction | | |
| 76 | 12 | 33 | Good | 4968350 | 2.75 |
| | | | diffraction | | |
| 77 | 7 | 1 | Poor | 4931648 | 0.142857 |
| | | | diffraction | | |
| 78 | 10 | 1 | Bad | 4882774 | 0.1 |
| | | | diffraction | | |
| 79 | 7 | 0 | Poor | 4840716 | 0 |
| | | | diffraction | | |
| 80 | 13 | 27 | Good | 4809129 | 2.076923 |
| | | | diffraction | | |
| 81 | 17 | 5 | Bad | 4761890 | 0.294118 |
| | | | diffraction | | |
| 82 | 16 | 53 | Good | 4744460 | 3.3125 |
| | | | diffraction | | |
| 83 | 14 | 403 | Good | 4722785 | 28.78571 |
| | | | diffraction | | |
| 84 | 12 | 19 | Good | 4680069 | 1.583333 |
| | | | diffraction | | |
| 85 | 8 | 1 | Poor | 4644325 | 0.125 |
| | | | diffraction | | |
| 86 | 8 | 1 | Poor | 4616873 | 0.125 |
| | | | diffraction | | |
| 87 | 13 | 331 | Good | 4617451 | 25.46154 |
| | | | diffraction | | |
| 88 | 6 | 1 | Poor | 4565630 | 0.166667 |
| | | | diffraction | | |
| 89 | 8 | 1 | Poor | 4554465 | 0.125 |
| | | | diffraction | | |
| 90 | 8 | 1 | Poor | 4526625 | 0.125 |
| | | | diffraction | | |
| 91 | 6 | 1 | Poor | 4497184 | 0.166667 |
| | | | diffraction | | |
| 92 | 8 | 1 | Poor | 4482229 | 0.125 |
| | | | diffraction | | |
| 93 | 4 | 1 | Poor | 4463886 | 0.25 |
| | | | diffraction | | |
| 94 | 3 | 1 | Poor | 4437105 | 0.333333 |
| | | | diffraction | | |
| 95 | 1 | 1 | No | 4386907 | 1 |
| | | | diffraction | | |
| 96 | 1 | 1 | No | 4301340 | 1 |
| | | | diffraction | | |
| 97 | 1 | 1 | No | 4174749 | 1 |
| | | | diffraction | | |
| 98 | 0 | 1 | No | 4011960 | 0 |
| | | | diffraction | | |
| 99 | 0 | 1 | No | 3845702 | 0 |
| | | | diffraction | | |
| 100 | 0 | 1 | No | 3675112 | 0 |
| | | | diffraction | | |
| | | | | | 14.90131 |

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A method of determining the crystal structure of a molecule, comprising:
providing a sample grid comprising a plurality of crystals of the molecule;
contacting the plurality of crystals with an incident beam of electrons; thereby generating a plurality of diffraction snapshots from each of a plurality of discrete locations within an area of the sample grid;
assessing, using a classification algorithm, a quality of the plurality of diffraction snapshots based on a total diffraction intensity, a number of diffraction peaks, and a crystallite lattice quality;
thereby generating a diffraction quality classification;
generating a ranked list of crystal targets based on the diffraction quality classification;
selecting a subset of crystal targets based on their ranking in the ranked list of crystal targets;
obtaining one or more redundant diffraction data sets from the subset of crystal targets; and
applying direct methods to the one or more redundant diffraction data sets; thereby determining the crystal structure of the molecule;
wherein the one or more redundant diffraction data sets comprise an improved parameter selected from CC½, completeness, Rint, I/σ, and R_{merge}, as compared to one or more redundant diffraction data sets generated without the classification algorithm.

2. The method of claim 1, wherein the method does not comprise real-space imaging.

3. The method of claim 1, wherein the method comprises about 1-30 minutes of real-space imaging.

4. The method of claim 1, wherein the classification algorithm is selected from a machine learning model, a deep learning model, an azimuthal uniformity test, a Wilson plot linearity, a 2D autocorrelation, a spot shape analysis, a lattice residual scoring, and a Ripley's K-function.

5. (canceled)

6. The method of claim 1, wherein the diffraction quality classification generated by the classification algorithm achieves a Cohen's kappa coefficient of greater than about 0.5 as compared to a diffraction quality classification generated without the classification algorithm.

7-11. (canceled)

12. The method of claim 1, wherein the improved parameter is completeness.

13. The method of claim 12, wherein completeness is increased by about 1-50% as compared to one or more redundant diffraction data sets generated without the classification algorithm.

14-15. (canceled)

16. The method of claim 1, wherein the improved parameter is Rint.

17. The method of claim 16, wherein Rᵢₙₜ is decreased by about 1-50% as compared to one or more redundant diffraction data sets generated without the classification algorithm.

18-19. (canceled)

20. The method of claim 1, wherein the improved parameter is I/σ.

21. The method of claim 20, wherein I/σ is increased by about 1-10 units as compared to one or more redundant diffraction data sets generated without the classification algorithm.

22. (canceled)

23. The method of claim 1, wherein the improved parameter is R_{merge}.

24. The method of claim 23, wherein R_{merge} is reduced as compared to one or more redundant diffraction data sets generated without the classification algorithm.

25. The method of claim 1, wherein the improved parameter is CC½.

26. The method of claim 25, wherein CC½ is increased by about 1-50% as compared to one or more redundant diffraction data sets generated without the classification algorithm.

27. (canceled)

28. The method of claim 1, wherein the one or more redundant diffraction data sets has an improved residual electron density distribution as compared to one or more redundant diffraction data sets generated without the classification algorithm.

29. (canceled)

30. The method of claim 1, wherein the one or more redundant diffraction data sets comprises 1-15 redundant diffraction data sets.

31. (canceled)

32. The method of claim 1, wherein each crystal target in the ranked list of crystal targets is separated by a minimum spacing of about 10 μm on the sample grid.

33. The method of claim 1, wherein the molecule is a small molecule or a macromolecule.

34. (canceled)

35. A method of determining the crystal structure of a molecule, comprising:
providing a sample grid comprising a plurality of crystals of the molecule;
contacting the plurality of crystals with an incident beam of electrons; thereby generating a plurality of diffraction snapshots from each of a plurality of discrete locations within an area of the sample grid;
generating a diffraction quality classification using a means for assessing a quality of the plurality of diffraction snapshots;
generating a ranked list of crystal targets using a means for correlating the ranked list of crystal targets with the diffraction quality classification;
selecting a subset of crystal targets based on their ranking in the ranked list of crystal targets;
obtaining one or more redundant diffraction data sets from the subset of crystal targets using a means for obtaining one or more redundant diffraction data sets; and
applying direct methods to the one or more redundant diffraction data sets; thereby determining the crystal structure of the molecule.

36-61. (canceled)
